(19) United States
(12) Patent Application Publication
(10) Pub. No.: US 2026/0214250 A1
(43) Pub. Date: Jul. 23, 2026

(54) INTRA PREDICTION WITH REGION-BASED DERIVATION

(71) Applicant: MEDIATEK INC., Hsinchu City (TW)

(72) Inventors: Man-Shu CHIANG, Hsinchu City (TW); Chih-Wei HSU, Hsinchu City (TW); Tzu-Der CHUANG, Hsinchu City (TW); Ching-Yeh CHEN, Hsinchu City (TW); Yi-Wen CHEN, San Jose, CA (US)

(21) Appl. No.: 19/141,172

(22) PCT Filed: Dec. 19, 2023
(86) PCT No.: PCT/CN2023/139823

§ 371 Date: Jun. 19, 2025

Related U.S. Application Data
(60) Provisional application No. 63/476,170, filed on Dec. 20, 2022.
(60) Provisional application No. 63/476,662, filed on Dec. 22, 2022.

(51) Int. Cl. H04N 19/196; H04N 19/105; H04N 19/159; H04N 19/176; H04N 19/593

(52) U.S. Cl. CPC H04N 19/196; H04N 19/105; H04N 19/159; H04N 19/176; H04N 19/593

(57) ABSTRACT

A method for implicitly deriving region-based intra-prediction is provided. The video coder derives multiple intra-prediction modes based on a reference region neighboring a current block among already-reconstructed pixels of a current picture. The current block is divided into grids that are aligned with sub-regions in the reference regions. The video coder generates a predictor for the current block using the multiple intra-prediction modes by generating an intra-prediction for each grid based on two or more intra-prediction modes that are derived based on two or more sub-regions aligned with the grid. The video coder may also identify a to-be-referenced intra prediction mode for use by subsequent coding operations of the current block and/or a subsequent block. The video coder encodes or decodes the current block by using the generated predictor to reconstruct the current block.

### CROSS REFERENCE TO RELATED PATENT APPLICATION(S)

The present disclosure is part of a non-provisional application that claims the priority benefit of U.S. Provisional Patent Application Nos. 63/476,170 and 63/476,662, filed on 20 Dec. 2022 and 22 Dec. 2022, respectively. Contents of above-listed applications are herein incorporated by reference.

### TECHNICAL FIELD

The present disclosure relates generally to video coding. In particular, the present disclosure relates to methods of coding pixel blocks by intra-prediction.

### BACKGROUND

Unless otherwise indicated herein, approaches described in this section are not prior art to the claims listed below and are not admitted as prior art by inclusion in this section.

High-Efficiency Video Coding (HEVC) is an international video coding standard developed by the Joint Collaborative Team on Video Coding (JCT-VC). HEVC is based on the hybrid block-based motion-compensated DCT-like transform coding architecture. The basic unit for compression, termed coding unit (CU), is a 2N×2N square block of pixels, and each CU can be recursively split into four smaller CUs until the predefined minimum size is reached. Each CU contains one or multiple prediction units (PUs). A block of pixels (e.g., a CU) currently being encoded or decoded may be referred to as the current block.

Versatile video coding (VVC) is the latest international video coding standard developed by the Joint Video Expert Team (JVET) of ITU-T SG16 WP3 and ISO/IEC JTC1/SC29/WG11. The input video signal is predicted from the reconstructed signal, which is derived from the coded picture regions. The prediction residual signal is processed by a block transform. The transform coefficients are quantized and entropy coded together with other side information in the bitstream. The reconstructed signal is generated from the prediction signal and the reconstructed residual signal after inverse transform on the de-quantized transform coefficients. The reconstructed signal is further processed by in-loop filtering for removing coding artifacts. The decoded pictures are stored in the frame buffer for predicting the future pictures in the input video signal.

In VVC, a coded picture is partitioned into non-overlapped square block regions represented by the associated coding tree units (CTUs). The leaf nodes of a coding tree correspond to the coding units (CUs). A coded picture can be represented by a collection of slices, each comprising an integer number of CTUs. The individual CTUs in a slice are processed in raster-scan order. A bi-predictive (B) slice may be decoded using intra prediction or inter prediction with at most two motion vectors and reference indices to predict the sample values of each block. A predictive (P) slice is decoded using intra prediction or inter prediction with at most one motion vector and reference index to predict the sample values of each block. An intra (I) slice is decoded using intra prediction only.

A CTU can be partitioned into one or multiple non-overlapped coding units (CUs) using the quadtree (QT) with nested multi-type-tree (MTT) structure to adapt to various local motion and texture characteristics. A CU can be further split into smaller CUs using one of the five split types: quad-tree partitioning, vertical binary tree partitioning, horizontal binary tree partitioning, vertical center-side triple-tree partitioning, horizontal center-side triple-tree partitioning.

Each CU contains one or more prediction units (PUs). The prediction unit, together with the associated CU syntax, works as a basic unit for signaling the predictor information. The specified prediction process is employed to predict the values of the associated pixel samples inside the PU. Each CU may contain one or more transform units (TUs) for representing the prediction residual blocks. A transform unit (TU) is comprised of a transform block (TB) of luma samples and two corresponding transform blocks of chroma samples and each TB correspond to one residual block of samples from one color component. An integer transform is applied to a transform block. The level values of quantized coefficients together with other side information are entropy coded in the bitstream. The terms coding tree block (CTB), coding block (CB), prediction block (PB), and transform block (TB) are defined to specify the 2-D sample array of one-color component associated with CTU, CU, PU, and TU, respectively. Thus, a CTU consists of one luma CTB, two chroma CTBs, and associated syntax elements. A similar relationship is valid for CU, PU, and TU.

For each inter-predicted CU, motion parameters consisting of motion vectors, reference picture indices and reference picture list usage index, and additional information are used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU. The alternative to merge mode is the explicit transmission of motion parameters, where motion vector, corresponding reference picture index for each reference picture list and reference picture list usage flag and other needed information are signalled explicitly per each CU.

### SUMMARY

The following summary is illustrative only and is not intended to be limiting in any way. That is, the following summary is provided to introduce concepts, highlights, benefits and advantages of the novel and non-obvious techniques described herein. Select and not all implementations are further described below in the detailed description. Thus, the following summary is not intended to identify essential features of the claimed subject matter, nor is it intended for use in determining the scope of the claimed subject matter.

Some embodiments of the disclosure provide a method for deriving region-based intra-prediction. The video coder may use region-based intra-prediction if a size of the current block (e.g., width and/or height) is greater than a threshold. The video coder derives multiple intra-prediction modes based on a reference region neighboring the current block among already-reconstructed pixels of the current picture. The current block is divided into grids that are aligned with sub-regions in the reference regions. The video coder generates a predictor for the current block using the multiple intra-prediction modes by generating an intra-prediction for each grid based on two or more intra-prediction modes that are derived based on two or more sub-regions aligned with the grid. The video coder encodes or decodes the current block by using the generated predictor to reconstruct the current block.

In some embodiments, the reference region includes an above reference region and a left reference region that are divided into multiple sub-regions. The current block is divided into grids and the sub-regions of the top and left reference regions are aligned with the grids. In some embodiments, (at least one of) the plurality of intra-prediction modes includes (at least one of) respective representative intra-prediction modes corresponding to the plurality of sub-regions, and for each sub-region, samples neighboring the sub-region are used to identify the representative intra-prediction mode of the sub-region.

In some embodiments, the predictor includes intra-prediction of each grid based on intra-prediction modes for sub-regions aligned with the grid. In some embodiments, the predictor of a grid is generated by blending a first intra prediction generated by a first intra-prediction mode derived from the above region or a sub-region of the above reference region aligned with the grid and a second intra prediction generated by a second intra-prediction mode derived from the left reference region or a sub-region of the left reference region aligned with the grid. In some embodiments, the first and second intra predictions at a sample in the grid are blended according to a weighting that is assigned based on the sample's respective distances from the above and left reference regions.

In some embodiments, the video coder generates the predictor of a first grid by blending a first intra prediction generated by a first intra-prediction mode derived from a first sub-region aligned with the first grid and a second intra prediction generated by a second intra-prediction mode derived from a second sub-region aligned with the second grid that is adjacent to the first grid.

In some embodiments, when a first cost based on a plurality of costs of respective representative intra-prediction modes corresponding to the plurality of sub-regions in the above reference region or the left reference region is less than a second cost of using a representative intra-prediction mode of the above reference region or the left reference region by considering a threshold, the predictor of the current block is generated by using at least one of the respective representative intra-prediction modes corresponding to the plurality of sub-regions in the above reference region or the left reference region. Otherwise, the predictor of the current block is generated by using the representative intra-prediction mode from the above reference region or the left reference region.

In some embodiments, the video coder identifies a to-be-referenced intra prediction mode. The to-be-referenced intra prediction mode is stored for the current block or propagated to the at least one subsequent block. The to-be-referenced intra prediction mode may be selected from a set of intra prediction modes based on costs, with the selected intra prediction mode from the set of intra prediction modes derived using predicted samples of the current block or reconstructed samples neighboring the current block. In some embodiments, the video coder encodes or decodes the current block by transforming or inverse transforming a residual of the predictor or transformed coefficients of the residual using a transform mode that is selected based on the to-be-referenced intra prediction mode. The video coder may also provide the to-be-referenced intra prediction mode for use as a most probable mode (MPM) for coding a subsequent block.

### BRIEF DESCRIPTION OF THE DRAWINGS

The accompanying drawings are included to provide a further understanding of the present disclosure, and are incorporated in and constitute a part of the present disclosure. The drawings illustrate implementations of the present disclosure and, together with the description, serve to explain the principles of the present disclosure. It is appreciable that the drawings are not necessarily in scale as some components may be shown to be out of proportion than the size in actual implementation in order to clearly illustrate the concept of the present disclosure.

FIG. 1 shows the intra-prediction modes in different directions.

FIGS. 2A-B conceptually illustrate top and left reference templates with extended lengths for supporting wide-angular direction mode for non-square blocks of different aspect ratios.

FIG. 3 illustrates using decoder-side intra mode derivation (DIMD) to implicitly derive an intra prediction mode for the current block.

FIG. 4 illustrates using template-based intra mode derivation (TIMD) to implicitly derive an intra prediction mode for a current block.

FIG. 5 conceptually illustrates neighboring reference regions that are divided into sub-regions when used to derive intra prediction modes.

FIG. 6 shows an example neighboring L-shaped reference region of the current block.

FIG. 7 illustrates an extended L-shaped reference region having extended top reference region and left reference region.

FIG. 8 shows the top-left region of the neighboring L-shape that is excluded for deriving one or more intra prediction modes for a current block.

FIG. 9 shows candidate intra prediction modes for a sub-region, including the most probable modes (MPMs) of the sub-region, particularly for the sub-region A₁ in the top reference region.

FIG. 10 illustrates using an adjacent L-shape region of a target region to generate predictors for the target region of the current block.

FIG. 11 illustrates using an outer L-shape of the top and left reference regions of the current block to generate predictors for the target region of the current block.

FIG. 12 illustrates one representative intra prediction mode from the top reference region and one representative intra prediction mode from the left reference region.

FIGS. 13A-B show an example of generating prediction hypotheses according to representative intra prediction modes.

FIG. 14 shows weights (for prediction generated using the intra prediction mode from the above reference region) that are assigned to samples based on positions.

FIG. 15 shows representative intra prediction modes of subblocks of a current block based on corresponding reference sub-regions.

FIGS. 16A-B show overlapping blending predictions along boundaries between grids of the current block.

FIG. 17 shows sample-based weighting for different positions in different sub-blocks.

FIG. 18 illustrates an example video encoder that may perform region based intra-prediction.

FIG. 19 illustrates portions of the video encoder that implement region-based intra prediction.

FIG. 20 conceptually illustrates a process for using region-based intra-prediction to encode the current block.

FIG. 21 illustrates an example video decoder that may perform region based intra-prediction.

FIG. 22 illustrates portions of the video decoder that implement region-based intra prediction.

FIG. 23 conceptually illustrates a process for using region-based intra-prediction to decode the current block.

FIG. 24 conceptually illustrates an electronic system with which some embodiments of the present disclosure are implemented.

### DETAILED DESCRIPTION

In the following detailed description, numerous specific details are set forth by way of examples in order to provide a thorough understanding of the relevant teachings. Any variations, derivatives and/or extensions based on teachings described herein are within the protective scope of the present disclosure. In some instances, well-known methods, procedures, components, and/or circuitry pertaining to one or more example implementations disclosed herein may be described at a relatively high level without detail, in order to avoid unnecessarily obscuring aspects of teachings of the present disclosure.

### I. Intra Prediction Modes

Intra-prediction method exploits one or more reference tiers adjacent to the current prediction unit (PU) and one of the intra-prediction modes to generate the predictors for the current PU. The Intra-prediction direction can be chosen among a mode set containing multiple prediction directions. In some embodiments, the intra prediction mode is not limited to referring to an Intra-prediction direction, DC mode, or Planar mode. The intra prediction mode may refer to any intra mode which determines the predictor of the current block using the spatially reconstructed samples. For example, the intra prediction mode refers to a filtering model which includes model parameters. The pre-defined inputs with the filtering model can be used to generate intra predictor of the current block. For each PU coded by Intra-prediction, one index will be used and encoded to select one of the intra-prediction modes. The corresponding prediction will be generated and then the residuals can be derived and transformed.

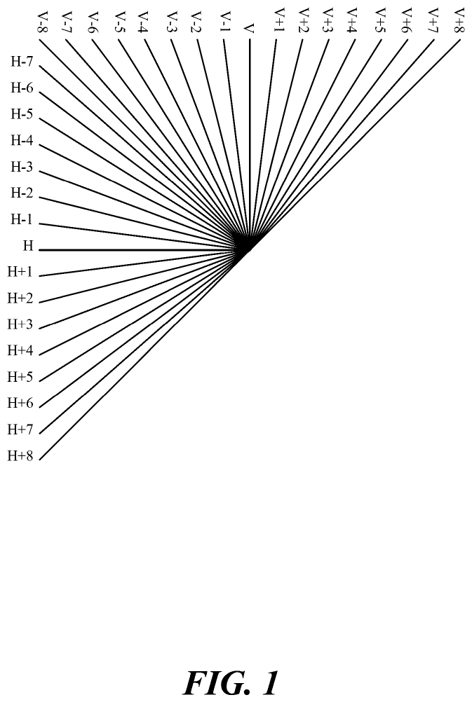

FIG. 1 shows the intra-prediction modes in different directions. These intra-prediction modes are referred to as directional modes and do not include DC mode or Planar mode. As illustrated, there are 33 directional modes (V: vertical direction; H: horizontal direction), so H, H+1~H+8, H−1~H−7, V, V+1~V+8, V−1~V−8 are used. Generally directional modes can be represented as either as H+k or V+k modes, where k=±1, ±2, . . . , ±8. Each of such intra-prediction mode can also be referred to as an intra-prediction angle. To capture arbitrary edge directions presented in natural video, the number of directional intra modes may be extended from 33, as used in HEVC, to 65 direction modes so that the range of k is from ±1 to ±16. These denser directional intra prediction modes apply for all block sizes and for both luma and chroma intra predictions. By including DC and Planar modes, the number of intra-prediction mode is 35 (or 67).

Out of the 35 (or 67) intra-prediction modes, some modes (e.g., 3 or 5) are identified as a set of most probable modes (MPM) for intra-prediction in current prediction block. The encoder may reduce bit rate by signaling an index to select one of the MPMs instead of an index to select one of the 35 (or 67) intra-prediction modes. For example, the intra-prediction mode used in the left prediction block and the intra-prediction mode used in the above prediction block are used as MPMs. When the intra-prediction modes in two neighboring blocks use the same intra-prediction mode, the intra-prediction mode can be used as an MPM. When only one of the two neighboring blocks is available and coded in directional mode, the two neighboring directions immediately next to this directional mode can be used as MPMs. DC mode and Planar mode are also considered as MPMs to fill the available spots in the MPM set, especially if the above or top neighboring blocks are not available or not coded in intra-prediction, or if the intra-prediction modes in neighboring blocks are not directional modes. If the intra-prediction mode for current prediction block is one of the modes in the MPM set, 1 or 2 bits are used to signal which one it is. Otherwise, the intra-prediction mode of the current block is not the same as any entry in the MPM set, and the current block will be coded as a non-MPM mode. There are all-together 32 such non-MPM modes and a (5-bit) fixed length coding method is applied to signal this mode.

The MPM list is constructed based on intra modes of the left and above neighboring block. Suppose the mode of the left neighboring block is denoted as Left and the mode of the above neighboring block is denoted as Above, and the unified MPM list may be constructed as follows:
When a neighboring block is not available, its intra mode is set to Planar by default.
If both modes Left and Above are non-angular modes:
   MPM list→{Planar, DC, V, H, V−4, V+4}
If one of modes Left and Above is angular mode, and the other is non-angular:
   Set a mode Max as the larger mode in Left and Above
   MPM list→{Planar, Max, Max−1, Max+1, Max−2, Max+2}
If Left and Above are both angular and they are different:
   Set a mode Max as the larger mode in Left and Above
   Set a mode Min as the smaller mode in Left and Above
   If Max−Min is equal to 1:
      MPM list→{Planar, Left, Above, Min−1, Max+1, Min−2}
   Otherwise, if Max−Min is greater than or equal to 62:
      MPM list→{Planar, Left, Above, Min+1, Max−1, Min+2}
   Otherwise, if Max-Min is equal to 2:
      MPM list→{Planar, Left, Above, Min+1, Min−1, Max+1}
   Otherwise:
      MPM list→{Planar, Left, Above, Min−1, Min+1, Max−1}
If Left and Above are both angular and they are the same:
   MPM list→{Planar, Left, Left−1, Left+1, Left−2, Left+2}

Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indices, which are remapped to indices of wide angular modes after parsing.

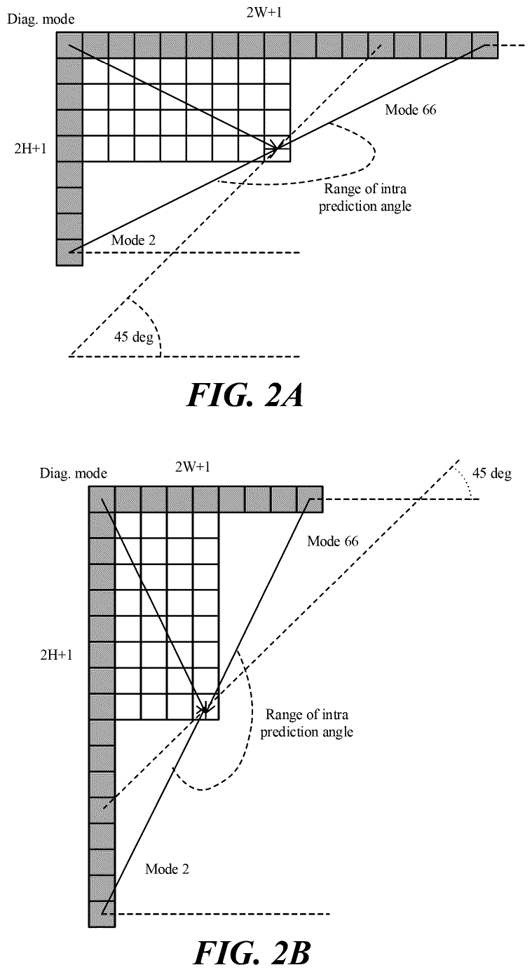

For some embodiments, the total number of intra prediction modes is unchanged, i.e., 67, and the intra mode coding method is unchanged. To support these prediction directions, a top reference template with length 2 W+1 and a left reference template with length 2H+1 are defined. FIGS. 2A-B conceptually illustrate top and left reference templates with extended lengths for supporting wide-angular direction mode for non-square blocks of different aspect ratios.

The number of replaced modes in wide-angular direction mode depends on the aspect ratio of a block. The replaced intra prediction modes for different blocks of different aspect ratios are shown in Table 1 below.

TABLE 1
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == 1/2 | Modes 59, 60, 61, 62, 63, 64, 65, 66 |
| W/H == 1/4 | Modes 57, 58, 59, 60, 61, 62, 63, 64, 65, 66 |
| W/H == 1/8 | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, |
| | 65, 66 |

### II. Decoder Side Intra Mode Derivation (DIMD)

Decoder-Side Intra Mode Derivation (DIMD) is a technique in which two or more intra prediction modes/angles/directions are derived from the reconstructed neighbor samples (template) of a block, and those two or more predictors are combined with the planar mode predictor with the weights derived from the gradients. The DIMD mode is used as an alternative prediction mode and is always checked in high-complexity RDO mode. To implicitly derive the intra prediction modes of a blocks, a texture gradient analysis is performed at both encoder and decoder sides. This process starts with an empty Histogram of Gradient (HoG) having 65 entries, corresponding to the 65 angular/directional intra prediction modes. Amplitudes of these entries are determined during the texture gradient analysis.

A video coder performing DIMD performs the following steps: in a first step, the video coder picks a template of T=3 columns and lines from respectively left and above the current block. This area is used as the reference for the gradient based intra prediction modes derivation. In a second step, the horizontal and vertical Sobel filters are applied on all 3×3 window positions, centered on the pixels of the middle line of the template. On each window position, Sobel filters calculate the intensity of pure horizontal and vertical directions as Gₓ and G_{y}, respectively. Then, the texture angle of the window is calculated as:

$$angle = arc tan ( {G}_{x} / {G}_{y} ) ,$$

which can be converted into one of the 65 angular intra prediction modes. Once the intra prediction modes index of current window is derived as idx, the amplitude of its entry in the HoG[idx] is updated by addition of

$$ampl = \vert {G}_{x} \vert + \vert {G}_{y} \vert$$

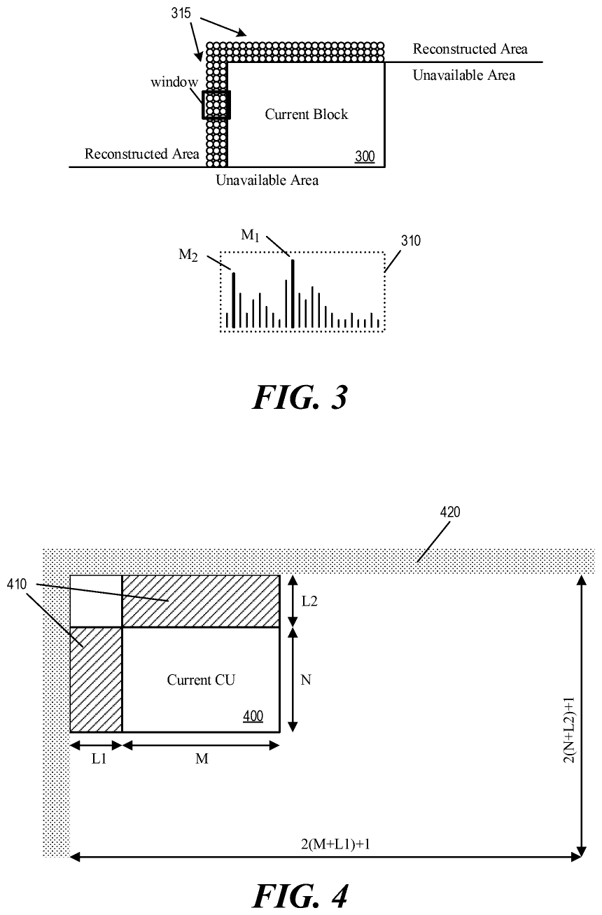

FIG. 3 illustrates using decoder-side intra mode derivation (DIMD) to implicitly derive an intra prediction mode for the current block. The figure shows an example Histogram of Gradient (HoG) 310 that is calculated after applying the above operations on all pixel positions in a template 315 that includes neighboring lines of pixel samples around a current block 300. Once the HoG is computed, the indices of the two or more tallest histogram bars (M₁ and M₂) are selected as the two or more implicitly derived intra prediction modes (IPMs) for the block. The prediction of the two or more IPMs are further combined with the planar mode as the prediction of DIMD mode. If only two IPMs and planar are used for generating predictors, the prediction fusion is applied as a weighted average of the above three predictors (M₁ prediction, M₂ prediction, and planar mode prediction). To this aim, the weight of planar may be set to 21/64 (~⅓). The remaining weight of 43/64 (~⅔) is then shared between the two HoG IPMs, proportionally to the amplitude of their HoG bars. The prediction fusion or combined prediction for DIMD can be:

$$\begin{matrix}{Pred}_{DIMD} = ( 43 * ( w 1 * {pred}_{M 1} + w 2 * {pred}_{M 2} ) + 21 * {pred}_{planar} ) >> 6 \\ w 1 = am {p}_{M 1} / ( am {p}_{M 1} + a m {p}_{M 2} ) \\ w 2 = am {p}_{M 2} / ( am {p}_{M 1} + a m {p}_{M 2} )\end{matrix}$$

In addition, the two or more implicitly derived intra prediction modes are added into the most probable modes (MPM) list, so the DIMD process is performed before the MPM list is constructed. The primary derived intra mode of a DIMD block is stored with a block and is used for MPM list construction of the neighboring blocks.

### III. Template-based Intra Mode Derivation (TIMD)

For mode selection, template matching method can be applied by computing the cost between reconstructed samples and predicting samples. One of the examples is template-based intra mode derivation (TIMD). TIMD is a coding method in which the intra prediction mode of a CU is implicitly derived by using a neighboring template at both encoder and decoder, instead of the encoder signaling the exact intra prediction mode to the decoder.

FIG. 4 illustrates using template-based intra mode derivation (TIMD) to implicitly derive an intra prediction mode for a current block 400. As illustrated, the neighboring pixels of the current block 400 is used as template 410. For each candidate intra prediction mode, prediction samples of the template 410 are generated using the reference samples, which are in a L-shape reference region 420 above and left of the template 410. A template matching (TM) cost (or called TIMD cost) for a candidate intra prediction mode cost is calculated based on a difference (e.g., SATD) between reconstructed samples of the template and the prediction samples of the template generated by the candidate intra prediction mode. One or more candidate intra prediction modes with the minimum costs are selected (as one or more candidate intra prediction modes with tallest histogram bars or HoGs in the DIMD mode) and used for intra prediction of the CU. The candidate modes may include 67 intra prediction modes (as in VVC) or extended to 131 intra prediction modes. MPMs may be used to indicate the directional information of a CU. Thus, to reduce the intra mode search space and utilize the characteristics of a CU, the intra prediction mode is implicitly derived from the MPM list.

In some embodiments, for each intra prediction mode in the candidate intra prediction modes of TIMD (for example, MPM list), the sum of absolute transformed differences (SATD) between the prediction and reconstructed samples of the template is calculated as the TM cost of the intra mode. First two or more intra prediction modes with the minimum SATD are selected as the TIMD modes. These two TIMD modes are fused with the weights after applying PDPC process, and such weighted intra prediction is used to code the current CU. Position dependent intra prediction combination (PDPC) is included in the derivation of the TIMD modes.

If only the first two intra prediction modes with the minimum SATD are selected as the TIMD modes, the costs of two selected modes (mode1 and mode2) are compared with a threshold, for example, the cost factor of 2 is applied as follows:

$$costMode 2 < 2 * costMode 1$$

If this condition is true, the prediction fusion is applied, otherwise only mode1 is used. Weights of the modes are computed from their SATD costs as follows:

$$\begin{matrix}weight 1 = costMode 2 / ( costMode 1 + costMode 2 ) \\ weight 2 = 1 - weight 1\end{matrix}$$

### IV. Region-Based Intra-Prediction

Some embodiments of the disclosure provide a region-based intra-prediction method of deriving one or more intra prediction modes for the current block. Neighboring L-shape reference samples (e.g., neighboring reconstructed and/or predicted samples), or any extension or subset of the neighboring L-shape reference samples may be used when deriving the one or more intra prediction modes. In some embodiments, the neighboring reference samples used for deriving the intra prediction modes are divided into one or more sub-regions and a pre-defined derivation method is performed on a sub-region to obtain a representative intra prediction mode from the sub-region.

### A. Intra Prediction Mode Derivation

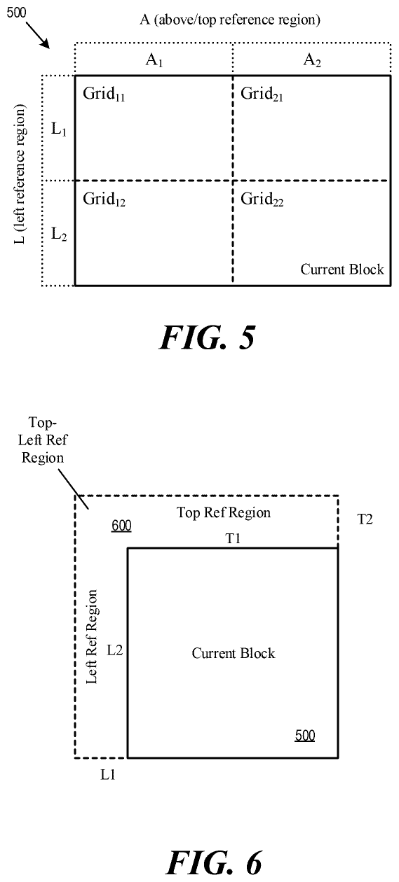

FIG. 5 conceptually illustrates neighboring reference regions that are divided into sub-regions when used to derive intra prediction modes. The figure illustrates a current block 500 that is to be coded by intra prediction. The current block 500 is divided into multiple grids that are denoted as grid₁₁, grid₁₂, grid₂₁, and grid₂₂. The samples neighboring the current block includes samples from a top (neighboring or reference) region above the current block and the left (neighboring or reference) region left of the current block. Samples of the left and/or top reference regions are used as neighboring reference samples for comparing template distortions for each candidate intra prediction mode (for example, TIMD costs on the left and/or top reference regions) or calculating histogram bars for each candidate intra prediction mode (for example, DIMD amplitudes on the left and/or top reference regions). In some embodiments, the top and/or left neighboring or reference regions are divided into sub-regions that are aligned with the grids of the current block. In the example illustrated, the top reference region is divided into sub-regions A₁ and A₂ and the left reference region is divided into sub-regions L₁ and L₂. When only vertical dividing is applied (for example, the block width larger than a pre-defined threshold and/or the block height not larger than the pre-defined threshold), only the top reference region is divided into sub-regions and/or the current block is vertically divided into grids. When only horizontal dividing is applied (for example, the block height larger than a pre-defined threshold and/or the block width not larger than the pre-defined threshold), only the left reference region is divided into sub-regions and/or the current block is horizontally divided into grids.

In some embodiments, for each sub-region, one or more intra prediction modes are identified to be the candidate intra prediction modes for the sub-region. In some embodiments, at least two intra prediction modes (at least one from the top reference region and at least one from left reference region) are derived from the sub-regions by a pre-defined implicit derivation scheme, based on the candidate intra prediction modes that are identified for the sub-regions.

In some embodiments, the best and/or second best intra prediction modes are identified or recorded for the current block. This best and/or second best intra prediction modes of the current block can be selected from the best and/or second best intra prediction modes (denoted as G′₀ and/or G′₁) for the whole top and left reference regions (A₁+A₂+L₁+L₂), the best and/or second best intra prediction modes (denoted as G′₂ and/or G′₃) for only the whole top region (A₁+A₂), and the best and/or second best intra prediction modes (denoted as G′₄ and/or G'₅) for only the whole left region (L₁+L₂) are recorded. The at least two intra prediction modes are then used to generate the intra-prediction of current block. In the example of FIG. 5, the top reference region (includes sub-regions A₁ and A₂) and the left reference region (including sub-regions L₁ and L₂) are used as the neighboring reference samples.

In some embodiments, for the different grids of the current block 500 (denoted as grid₁₁, grid₁₂, grid₂₁, and grid₂₂ in the example of FIG. 5), predictors based on one or more different prediction hypotheses are blended to create blended predictors. In some embodiments, the prediction hypotheses at least include one prediction hypothesis generated using the intra prediction mode (denoted as modeAᵢ) from the above neighboring sub-region (denoted as Aᵢ) and another prediction hypothesis generated using the intra prediction mode (denoted as modeLⱼ) from the left neighboring sub-region (denoted as Lⱼ). Then, modeA₁, modeA₂, modeL₁, and modeL₂ are derived from A₁, A₂, L₁, and L₂, respectively. Thus, for grid₁₁, the blended predictors are generated based on multiple prediction hypotheses that includes one hypothesis generated by modeA₁ and another hypothesis generated by modeL₁. Similar way is applied to the remaining grids. For grid₁₂, the blended predictors are based on prediction hypotheses generated from modeA₁ and modeL₂. For grid₂₁, the blended predictors are based on prediction hypotheses generated from modeA₂ and modeL₁. For grid₂₂, the blended predictors are based on prediction hypotheses generated from modeA₂ and modeL₂.

The neighboring reference samples may be provided by a L-shaped reference region neighboring the current block. FIG. 6 shows an example neighboring L-shaped reference region 600 of the current block 500. The neighboring L-shaped reference region 600 includes a top reference region, a left reference region, and/or a top-left reference region. The size of the top region is T1×T2, where T1 may be equal to the width of the current block and T2 may be equal to a pre-defined positive value. The size of the left region is L1×L2, where L1 may be equal to a pre-defined positive value and L2 may be equal to the height of the current block.

In some embodiments, the neighboring L-shaped reference region can be extended as to extend the top region width and/or to extend the left region height. In some embodiments, the top region width may be extended to k* block width, where k is larger than 1. Similarly, the left region height may be extended to k*the block height, where k is larger than 1. In some embodiments, the neighboring L-shape samples are the same as those used in intra prediction generation with or without excluding the padded samples in the unavailable region (out of picture boundary, un-causal region, etc.).

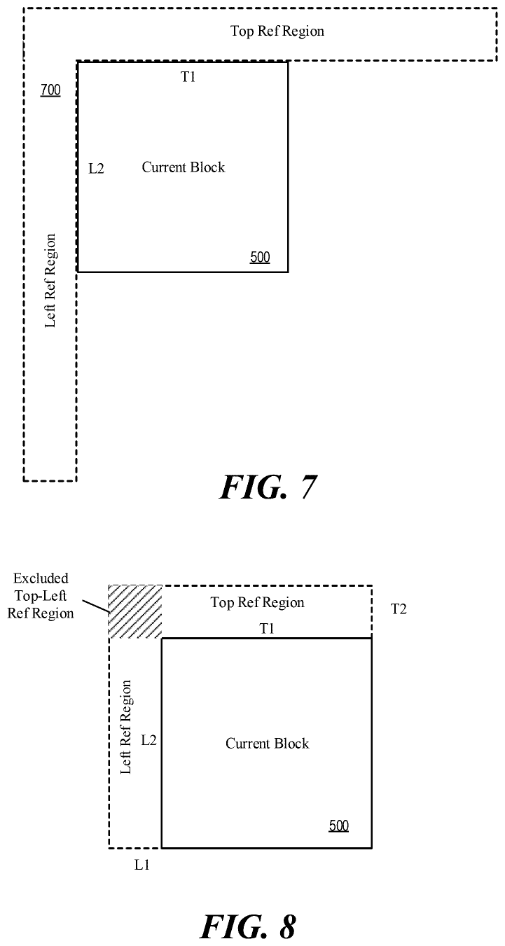

FIG. 7 illustrates an extended L-shaped reference region 700 having extended top reference region and left reference region. In some embodiments, the extension of the neighboring L-shape samples is used as extending the top region width and/or extending the left region height. The top region width is extended to the block width+a predefined k′. Similarly, the left region height is extended to the block height+a predefined k″. k′ and k″ can be set as any positive integers. For example, k′ is the block height and/or k″ is the block width.

In some embodiments, only a subset of the neighboring L-shape reference region is used, as samples in the top-left region of the neighboring L-shape reference region are excluded. FIG. 8 shows the top-left region of the neighboring L-shape that is excluded for deriving one or more intra prediction modes for a current block. In some embodiments, only samples in the top reference region of the neighboring L-shape reference region are used as reference samples for deriving one or more intra prediction modes for a current block. In some embodiments, only samples in the left reference region of the neighboring L-shape reference region are used for deriving one or more intra prediction modes for a current block.

In some embodiments, for the top reference region, a dividing factor M is pre-defined to divide the top reference region into the sub-regions with the sub-region width equal to T1/M. Similarly, another dividing factor N is pre-defined to divide the left region into the sub-regions with the sub-region height equal to L2/N. For example, when the block width is larger than a pre-defined threshold, Mis larger than 1. For example, when the block height is larger than a pre-defined threshold, N is larger than 1. For example, M and N may be set to a same value, where M=N=2, 4, 8, or any positive integer. For another example, M and N can be different. For another example, M and/or N can vary with the block width, block height, and/or block area of the current block. If width of the current block is larger than height of the current block, M is larger than N; otherwise, M is smaller than or equal to N. For another example, the dividing factors here will follow or align with the dividing for the current block described in the sections below.

In some embodiments, when Mis set equal to 1, no dividing process is applied to the top region and the only one sub-region on the top region refers to the top region, and only one representative intra prediction mode is derived from the top region according to the pre-defined implicit derivation scheme. Similarly, when N is set equal to 1, no dividing process is applied to the left region and the only one sub-region on the left region refers to the left region, and only one representative intra prediction mode is derived from the left region according to the pre-defined implicit derivation scheme.

In some embodiments, for each sub-region of the neighboring reference region (e.g., sub-regions A₁, A₂, L₁, and L₂ of reference region 600), a basic candidate list is built and is shared. The basic candidate list may include MPMs comprising spatial adjacent candidates and/or spatial non-adjacent candidates, and/or history-based candidates, and/or temporal candidates, and/or propagation candidates, some default intra prediction modes, some derived modes from some promising intra prediction modes, and/or any subset of available intra prediction modes. Spatial adjacent candidates can be from the left/above/above-left/above-right/bottom-left neighboring blocks of the current block, the left/above/above-left/above-right/bottom-left neighboring blocks of a target sub-region, and/or any subset of the above-mentioned positions. Spatial non-adjacent candidates can be from any pre-defined positions in a search pattern around the current block, any pre-defined positions in a search pattern around a target sub-region, and/or any subset of the above-mentioned positions. History-based candidates can be from a history buffer which stores multiple intra prediction mode information of the previous coded blocks which were coded before the current block and have valid intra prediction mode information. The history buffer is empty at a pre-defined timing. For example, the history buffer is empty at the beginning or the end of a slice, CTU/CTB, CTU/CTB row, picture, tile, sequence, and/or any pre-defined unit. Temporal candidates can be from a buffer which stores the intra prediction mode information at a referred reference position in the reference frame (or reference picture) and/or a pre-defined collocated picture, and/or stores the intra prediction mode information at any pre-defined positions nearing the referred reference position. For example, the referred reference position is the collocated block in the collocated picture. For another example, the referred reference position is indicated using the motion information of the neighboring blocks or any pre-defined blocks associated with the current block. Propagation candidates can be from the intra prediction mode information at one or more reference positions referring by the motion information of the neighboring blocks or any pre-defined blocks associated with the current block. For example, available intra prediction modes can be any subset of available intra prediction modes in a video coding standard (e.g., VVC) or a developing video coding software (e.g., ECM) such as 67 intra prediction modes, 131 intra prediction modes, or MIP modes. For another example, the default intra prediction modes can be some commonly used intra prediction modes such as any subset of DC, planar, horizontal, vertical, diagonal, inverse diagonal intra prediction modes.

The derived modes may be derived from a certain predefined set of representative intra prediction modes Gᵢ, where i=0, 1, 2, 3, 4 and/or 5. The mode index of a derived mode will be ranging in Gᵢ±a predefined positive integer offset.

In some embodiments, G₀ is selected among all or any subset of candidates in the basic candidate list with all or any subset of the derived modes excluded and G₀ means the best intra prediction mode obtained by performing a pre-defined implicit derivation scheme (which will be introduced later) on both the whole top and whole left regions. G₁ is determined with the same method as G₀ but G₁ is the second best intra prediction mode. G₂ is selected among all or any subset of candidates in the basic candidate list with all or any subset of the derived modes excluded and G₂ means the best intra prediction mode obtained by performing a pre-defined implicit derivation scheme (which will be introduced later) on only the whole top region. G₃ is determined with the same method as G₂ but G₃ is the second best intra prediction mode. G₄ is selected among all or any subset of candidates in the basic candidate list with all or any subset of the derived modes excluded and G₄ means the best intra prediction mode obtained by performing a pre-defined implicit derivation scheme (which will be introduced later) on only the whole left region. G₅ is determined with the same method as G₄ but G₅ is the second best intra prediction mode. The derived modes refer to the intra prediction modes which are derived based on one or more pre-defined intra prediction modes and/or one or more promising intra prediction modes among the intra prediction modes previously inserted into the candidate intra prediction mode list. For example, the intra mode index number of a deriving mode is calculated by adding a positive or negative offset to the intra mode index number of a pre-defined intra prediction mode or a promising intra prediction mode.

In some embodiments, the basic candidate list for a sub-region of the neighboring reference region may be further modified. In some embodiments, a sub-region may have its own candidate list. In some embodiments, each of a pre-selected set of sub-regions may have its own candidate list. Such a pre-selected set of sub-regions may include one or more sub-regions in only the left reference region, or the pre-selected set of sub-regions may include one or more sub-regions in only the above (top) reference region, or the pre-selected set of sub-regions may include one or more sub-regions in both the left and above regions.

In some embodiments, the basic candidate list refers to the candidate intra prediction modes generated by TIMD mode, as described in Section III above. In some embodiments, a unified candidate list of intra prediction modes that includes the TIMD intra prediction modes is used as the basic candidate list of a sub-region. In some embodiments, a candidate list is defined for each sub-region. The candidate list of a sub-region may initially include the basic candidate list of the sub-region. The candidate lists of different sub-regions may be same or different. For example, for a current sub-region, the derived modes of the representative (or promising) intra prediction mode, with the mode index ranging in the mode index of the representative intra prediction mode+/−a predefined positive integer offset from the previous sub-region, can be added to the candidate list for the current sub-region. For another example, the candidate list for each sub-region may include the derived modes with mode index ranging in {Gᵢ-offset1, Gᵢ+offset2}, where offset1 and offsest2 can be the same or different for different sub-regions. Offset1 and offsest2 may vary with the block width, height, or area. Offset1 and offsest2 may vary with the sub-region width, height, or area. Offset1 and offsest2 may vary with the calculated costs of the candidate mode. For the current sub-region, if the calculated costs (using in the pre-define implicit derivation scheme) are all larger than a pre-defined number (e.g., sub-region size), more candidate modes are needed, and offset1 and/or offset2 are increased. If any calculated cost is smaller than a pre-defined number (e.g., sub-region size), less candidate modes are needed and offset1 and/or offset2 are reduced. In some embodiments, G₀′ is selected among all candidate intra prediction modes for both above and left reference regions and G₀′ means the best intra prediction mode obtained by performing a pre-defined implicit derivation scheme (which will be introduced later) on both the whole top and whole left regions. G₁′ is determined with the same method as G₀′ but G₁′ is the second best intra prediction mode. G₂′ is selected among all candidate intra prediction modes for the above reference region and G₂′ means the best intra prediction mode obtained by performing a pre-defined implicit derivation scheme (which will be introduced later) on only the whole top region. G₃′ is determined with the same method as G₂′ but G₃′ is the second best intra prediction mode. G₄′ is selected among all candidate intra prediction modes for the left reference region and G₄′ means the best intra prediction mode obtained by performing a pre-defined implicit derivation scheme (which will be introduced later) on only the whole left region. G₅′ is determined with the same method as G₄′ but G₅′ is the second best intra prediction mode.

In some embodiments, two candidate lists are derived for the one or more sub-regions in the top reference region and the one or more sub-regions in the left reference region. Each sub-region in the top (above) reference region uses one candidate list and each sub-region in the left reference region uses the other candidate list. If a pre-defined implicit derivation scheme is initially performed on the left region, the representative intra prediction modes from left region and/or the derived modes of the representative intra prediction modes from left region may be added into the candidate list for the top region. Conversely, if a predefined implicit derivation scheme is first performed on the top region, the representative intra prediction modes from top region and/or the derived modes of the representative intra prediction modes from top region may be added into the candidate list for the left region.

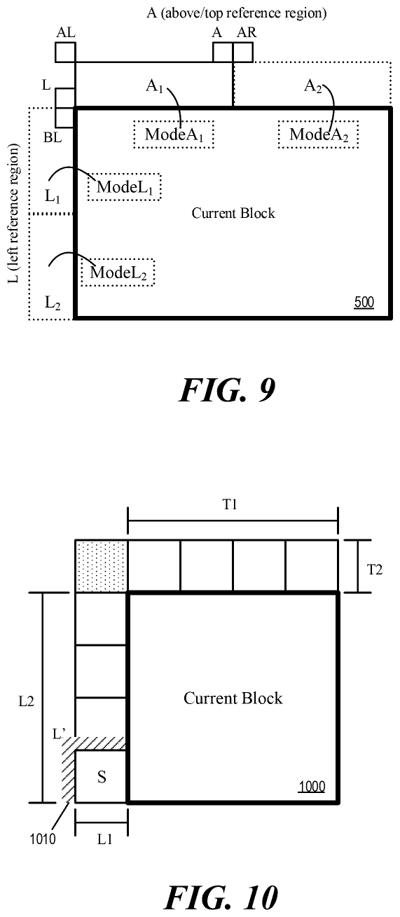

In some embodiments, at least one candidate list is derived for each sub-region. In some embodiments, for each sub-region, the candidate list includes MPMs for the current sub-region and/or the selected intra modes in the current sub-region. FIG. 9 shows candidate intra prediction modes for a sub-region, including the MPMs of the sub-region, particularly for the sub-region A₁ in the top reference region. As illustrated, when two representative intra prediction modes (denoted as modeA₁ and modeA₂) are derived based on the sub-regions of the above reference region and two representative intra prediction modes (denoted as modeL₁ and modeL₂) from derived from the sub-regions of the left reference region, for sub-region A₁, its MPMs may come from the spatially neighboring blocks of A₁ such as the above-left neighbor (denoted as AL), left neighbor (denoted as L), above neighbor (denoted as A), above-right neighbor (denoted as AR), and/or bottom-left neighboring (denoted as BL). Similar way is applied to other sub-regions (A₂, L₁, L₂).

In some embodiments, for each sub-region, the candidate list includes the derived modes for the current sub-region. The mode index of a derived mode for the current sub-region will be ranging in the mode index of a promising mode for the current sub-region+/−a predefined positive integer offset. The promising mode is selected from the candidate list for the current sub-region with all or any subset of the derived modes for the current sub-region excluded. The promising mode may be determined by the pre-defined implicit derivation scheme on the current sub-region. For example, the promising mode is the intra prediction mode with the smallest TIMD cost or the largest DIMD histogram among the candidate intra prediction modes (with derived modes excluded) for the current sub-region.

In some embodiments, for each sub-region, the candidate list includes any subset of available intra prediction modes. For example, available intra prediction modes can be any subset of available intra prediction modes in a video coding standard (e.g., VVC) or a developing video coding software (e.g., ECM) such as 67 intra prediction modes, 131 intra prediction modes, or MIP modes.

In some embodiments, a predefined implicit derivation scheme can be used on a target region (e.g., a sub-region of the top or left reference region) to determine intra prediction mode. The scheme can be a TIMD-like scheme or a DIMD-like scheme.

In some embodiments in which a TIMD-like scheme is used, the video coder may first generate predictors and calculate TIMD costs for each candidate mode (in the candidate list for the target region) on the target region using the TIMD process as described in Section III above. The intra prediction parameters (such as whether to apply PDPC, intra interpolation filter, . . . ) for generating predictors are unified with the TIMD process (as described in Section III above) or different from the TIMD process. The TIMD costs are calculated based on the distortions between the generated predictors and the reference samples within the target region. The distortion measurement metrics may be any pre-defined matrix, SAD, and/or SATD. In some embodiments, the distortion measurement on the template is not limited to using TIMD costs and/or DIMD HoGs. Any measurement on the template can be considered to derive and/or determine the intra prediction mode from the template region. For example, the measurement can use a regression method like Gaussian elimination method to approximate the reconstructed samples on the template. The intra prediction mode derived from the template will be the intra prediction mode which can generate the template predictor approximating to the template reconstruction. The video coder may then obtain the representative intra prediction mode from the target region by using the intra prediction mode with the best (smallest) TIMD cost among the candidate list. (In some cases, the intra prediction mode with the second best TIMD cost may be used instead.)

In some embodiments, when the target region is the whole top reference region, one representative intra prediction mode is derived from the entire top reference region. When the target region is a sub-region of the top reference region (which may include two or more sub-regions), one representative intra prediction mode is derived from each sub-region within the top reference region. A similar method is used for each sub-region within the left reference region.

In some embodiments in which a DIMD-like scheme (described in Section II above) is used, instead of calculating TIMD costs, gradient calculation is performed on the target region to obtain the representative intra prediction mode of on histograms of gradients (HoGs).

In some embodiments, when determining the representative intra prediction mode of a target region belonging to a sub-region or any region in the top and/or left reference regions and/or a sub-region or any region in FIG. 6, FIG. 7, and/or FIG. 8, an adjacent L shape of the target region is used as the reference samples to generate the predictors of the different candidate intra prediction modes for the target region. FIG. 10 illustrates using an adjacent L-shape region of a target region to generate predictors for the target region of the current block. The figure illustrates a target region (denoted as S) that is a sub-region of the neighboring reference region of a current block 1000. An adjacent L shape 1010 (denoted as L′) of the target region S is used to generate a predictor for the target region S. For the target region S, the cost of a certain candidate intra prediction mode is calculated by measuring the difference between the reconstructed samples and predicted samples of the target region S. Likewise, the cost of candidate intra prediction modes of other target regions can be determined by measuring the difference between the reconstructed samples and predicted samples of those other target regions.

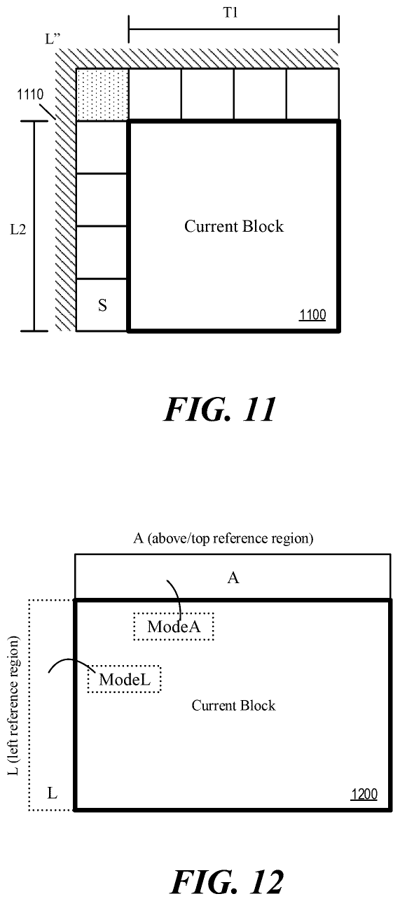

In some embodiments, when determining the representative intra prediction mode of a target region belonging to a sub-region or any region in the top and/or left reference regions and/or a sub-region or any region in FIG. 6, FIG. 7, and/or FIG. 8, an outer L shape of the top and left reference regions is used as the reference samples to generate the predictors of the different candidate intra prediction modes for the target region. FIG. 11 illustrates using an outer L-shape of the top and left reference regions of the current block to generate predictors for the target region of the current block. The figure illustrates a target region (denoted as S) that is a sub-region of the neighboring reference region of a current block 1100. The neighboring reference region includes top and left reference regions. Samples in an outer L-shape region 1110 (dented as L″) neighboring the top and left reference regions are used to generate the predictors for the top and left reference regions. For the target region S, the cost of a certain candidate intra prediction mode is calculated by measuring the difference between the reconstructed samples and predicted samples of the target region S. Likewise, the cost of candidate intra prediction modes of other target regions can be determined by measuring the difference between the reconstructed samples and predicted samples of those other target regions.

In some embodiments, the video coder directly references one or more stored intra prediction modes for the target region and selects one (among the stored intra prediction modes) to be the representative intra prediction mode for the target region. In some embodiments, the stored intra prediction modes are the intra prediction modes used for reconstructing the target region. In some embodiments, the stored intra prediction modes are stored in each 1×1, 2×2, 4×4, 8×8, 16×16, 32×32, or any pre-defined sub-block size. For example, for the sub-region A₁, each intra prediction mode stored in each sub-block within A₁ will be referenced and the selected one is the intra prediction mode used by most sub-blocks in A₁.

### B. Mode Replacement

When at least two representative intra prediction modes are derived to generate the prediction for the current block, some redundancy may occur when duplicated intra prediction modes exist in the representative intra prediction modes. In some embodiments, a mode replacement scheme may be used to remove the redundancy.

FIG. 12 illustrates one representative intra prediction mode from the top reference region and one representative intra prediction mode from the left reference region. As illustrated, one representative intra prediction mode (denoted as modeA) is derived for the above/top reference region and one representative intra prediction mode (denoted as modeL) is derived for the left reference region are derived. However, modeA may be the same as modeL and therefore redundant.

In some embodiments, the mode replacement scheme may be used to remove this redundancy. In some embodiments, the video coder may compare the TIMD cost (denoted as costA) of modeA and the TIMD cost (denoted as costL) of modeL and then replace the mode (either modeA or modeL) with the larger TIMD cost with the second best mode identified by the TIMD-like process. After the mode replacement, modeA and modeL are different. For example, if costA is larger than costL, the original modeA (referring to the best mode based on the above/top reference region) is replaced with the second best mode based on the above/top reference region. If costL is larger than or equal to costA, the original modeL (referring to the best mode on the left region) is replaced with the second best mode based on the left region. In some embodiments, when comparing TIMD costs, the video coder may normalize the TIMD costs if those TIMD costs are from different size of regions.

In some embodiments in which two representative intra prediction modes (e.g., modeA₁ and modeA₂ in FIG. 9) from the above reference region and two representative intra prediction modes (e.g., modeL₁ and modeL₂ in FIG. 9) from the left reference region are derived, redundancy may also occur and may need the mode replacement scheme. For example, modeA₁ may be the same as modeA₂ when checking the top reference region, and the video coder may use the predefined representative intra prediction mode (such as anyone of A₁, A₂, and Gₖ′ where k=0, 1, 2, or 3) for the whole top region, not to divide on the top region, and/or not to do vertical dividing on the current block. For another example, modeL₁ may be the same as modeL₂ when checking the left reference region, and the video coder may use the pre-defined representative intra prediction mode (such as any one of L₁, L₂, and Gₖ′ where k=0, 1, 4, or 5) for the whole left region, not to divide on the left region, and/or not to do horizontal dividing on the current block.

When the representative intra prediction modes from the sub-regions in the top reference region is not much better than the pre-defined representative intra prediction mode (such as any one of Gₖ′ where k=0, 1, 2, or 3) from the whole (top or left reference) region, the video coder may use the predefined representative intra prediction mode (such as any one of Gₖ′ where k=0, 1, 2, or 3) for the whole region, not to divide on the above region, and/or not to do vertical dividing on the current block. This may occur when K*{the summation of the TIMD cost from each sub-region in the top region} is larger than the TIMD cost of the pre-defined representative intra prediction mode. K can be any pre-defined value. For example, K is set as 2 or any value larger than 1. For another example, K is adaptive depending on quantization parameter (QP), sequence resolution, block width, block height, block area, and/or block mode information. The enabling condition of dividing here associated with costs can be used together with the enabling condition of dividing associated with the block width, block height, and/or block area. For example, when the block width is larger than a pre-defined threshold and the enabling condition of dividing here associated with costs are both satisfied, dividing can be applied on the above region, and/or vertical dividing can be applied on the current block.

When the representative intra prediction modes from the sub-regions in the left region is not much better than the predefined representative intra prediction mode (such as any one of Gₖ′ where k=0, 1, 4, or 5) from the whole region, the video coder may use the pre-defined representative intra prediction mode (such as any one of Gₖ′ where k=0, 1, 4, or 5) for the whole region, not to divide on the left region, and/or not to do horizontal dividing on the current block. This case may happen when {K*the summation of the TIMD cost from each sub-region in the left region} is larger than the TIMD cost of the pre-defined representative intra prediction mode. K can be any pre-defined value. For example, K is set as 2 or any value larger than 1. For another example, K is adaptive depending on quantization parameter (QP), sequence resolution, block width, block height, block area, and/or block mode information. The enabling condition of dividing here associated with costs can be used together with the enabling condition of dividing associated with the block width, block height, and/or block area. For example, when the block height is larger than a pre-defined threshold and the enabling condition of dividing here associated with costs are both satisfied, dividing can be applied on the left region, and/or horizontal dividing can be applied on the current block.

When modeAᵢ is the same as modeLⱼ when checking gridᵢⱼ, the video coder may compare the TIMD cost (denoted as costAᵢ) based on Aᵢ and the TIMD cost (denoted as costLⱼ) on Lⱼ and then replace the mode with the larger TIMD cost with the second best mode. After the mode replacement, modeAᵢ and modeLⱼ are different. If costAᵢ is larger than costLⱼ, the original modeAᵢ (referring to the best mode on Aᵢ) is replaced with the second best mode on Aᵢ. If costLⱼ is larger than or equal to costAᵢ, the original modeLⱼ (referring to the best mode on Lⱼ) is replaced with the second best mode based on Lⱼ.

In some embodiments, when comparing on TIMD costs, the video coder may normalize TIMD costs first if those TIMD costs are from different size of sub-regions. In some sub-embodiment, the above examples can be combined with any pre-defined order. In one case, those examples, which affect whether to divide on a region/current block, should be applied before other examples. In another case, those examples should be done before generating prediction for the current block.

### C. Prediction Generation and Blending

In some embodiments, when generating the predictors of the current block, a weighting scheme (including weight for each hypothesis) may be used to blend one or more prediction hypotheses from one or more representative intra prediction modes. A right-shifting process and/or a rounding factor may be used. For example, if the summation of the weights is 64, adding a rounding factor equal to 32, and a right-shift of 6 bits may be performed after blending.

In some embodiments, the one or more prediction hypotheses may only be generated by using the intra prediction modes from either the above or the left reference region. For example, if the summation of the TIMD costs from left region*a pre-defined threshold D is smaller than the summation of the TIMD costs from above region, the video coder may set the weights of the hypotheses from above region to zero. For another example, if the summation of the TIMD costs from above region*a pre-defined threshold D is smaller than the summation of the TIMD costs from left region, the video coder may set the weights of the hypotheses from left region to zero. D can be any pre-defined value. For example, D is set as 2 or any value to be larger than 1. For another example, D is adaptive depending on QP, sequence resolution, block width, block height, block area, and/or block mode information.

In some embodiments, the one or more prediction hypotheses may mainly be generated by using the intra prediction modes from either above or left region. For example, if the summation of the TIMD costs from left region*a pre-defined threshold is smaller than the summation of the TIMD costs from above region, the video coder may set the weights of the hypotheses from left region larger than the weights of the hypotheses from above region. For another example, if the summation of the TIMD costs from above region*a pre-defined threshold D is smaller than the summation of the TIMD costs from left region, the video coder may set the weights of the hypotheses from above region to be larger than the weights of the hypotheses from left region. D can be any pre-defined value. For example, D is set as 2 or any value larger than 1. For another example, D is adaptive depending on QP, sequence resolution, block width, block height, block area, and/or block mode information.

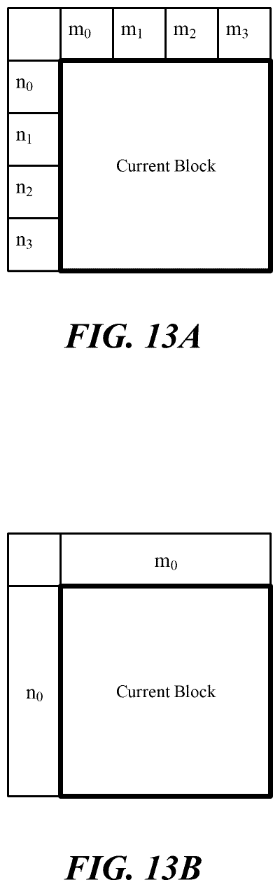

In some embodiments, the video coder may generate a prediction hypothesis for the current block (or one or more subblocks in the current block) according to each representative intra prediction mode. FIGS. 13A-B show an example of generating prediction hypotheses according to representative intra prediction modes. FIG. 13A shows 8 representative intra prediction modes in total (labeled as m₀, m₁, m₂, m₃, n₀, n₁, n₂, and n₃) for a current block based on neighboring information. Correspondingly, 8 prediction hypotheses for the current block are generated. The video coder then blends these prediction hypotheses for the current block according to a predefined weighting scheme. FIG. 13B shows 2 representative intra prediction modes (denoted as m₀ and n₀) for a current block based on the neighboring information. Correspondingly, 2 prediction hypotheses for the current block are generated. The video coder then blends these prediction hypotheses for the current block according to a predefined weighting scheme.

In some embodiments, the weighting is sample-based. That is, each sample is assigned its own weight. The weighting includes the weight for each prediction hypothesis. For example, p(x, y)=w₀(x,y)*p₀(x,y)+w₁(x,y)*p₁(x, y)+w₂(x,y)*p₂(x, y)+ . . . +w₇(x,y)*p₇(x, y), where (x, y) is the sample position in the current block, p(x, y) is the blended predictor at (x, y), pᵢ(x, y) is the to-be-blended predictor for (x, y) from the hypothesis i and wᵢ(x, y) is the weight for pᵢ(x, y). The weight is assigned to a sample and/or the weight is assigned or determined based on the sample's position within the current block, the block width (W) or height (H) of the current block, the cost of the representative intra prediction mode, and/or the distance between the sample's position and the corresponding region that provides the representative intra prediction for generating a prediction hypothesis i.

For example, prediction hypothesis p₀ is generated by m₀ (the representative intra prediction mode from above/top reference region A) and prediction hypothesis pᵢ is generated by no (the representative intra prediction mode from left reference region L). Weighting w₀(x, y) can be

$$I + \frac{I * x}{W} - \frac{I * y}{H} ,$$

where I depends on the predefined summation of weights. Weighting w₁ is (the summation of weights)−w₀. If the summation of weighting is 64, I=half of 64=32.

In some embodiments, the weighting may further depend on the costs of the representative intra prediction modes. The cost of m₀ is first normalized/scaled according to the top region area/size and the cost of n₀ is first normalized/scaled according to the left region area/size. For example, if the cost for m₀ is much larger than the cost from n₀, w₀ is reduced to

$$I + \frac{I * x}{W} - \frac{2 * I * y}{H} ;$$

if the cost for n₀ is much larger than the cost from m₀, w₀ is increased to

$$I + \frac{2 I * x}{W} - \frac{I * y}{H} .$$

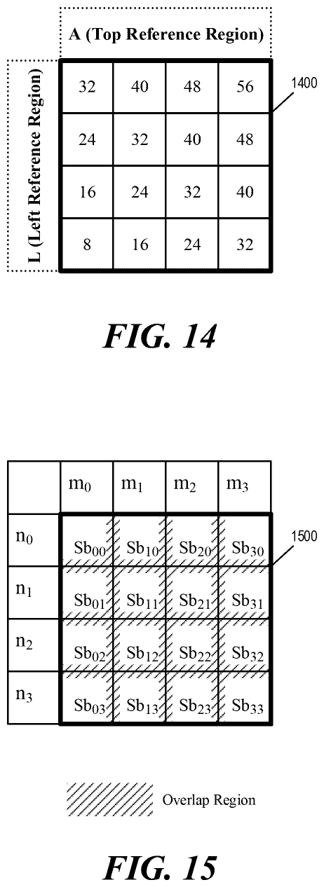

FIG. 14 shows weights (for prediction generated using the intra prediction mode from the above reference region) that are assigned to samples based on positions. The numbers in the figure correspond to w₀(x, y) for the sample (x, y) in a current block 1400.

In some embodiments, the current block is divided into several sub-blocks, and each subblock has one or more representative intra prediction modes from its corresponding one or more reference sub-region. FIG. 15 shows representative intra prediction modes of subblocks of a current block based on corresponding reference sub-regions. The figure shows a 64×64 current block 1500 that is divided into 16 subblocks (denoted as sbᵢⱼ, where i=0, 1, 2, or 3 and j=0, 1, 2, or 3). For subblock sb₀₀, its corresponding reference sub-regions include one sub-region from the top reference region and the other sub-region from left reference region, Therefore, sb₀₀ has one representative intra prediction mode from a corresponding above sub-region (denoted as m₀) and one representative intra prediction mode from a corresponding left sub-region (denoted as n₀). Similarly, sb₀₁ has corresponding representative intra prediction modes m₀ and n₁, sb₁₀ has corresponding representative intra prediction modes m₁ and n₀, etc.

In some embodiments, the weighting in each sub-block is sample-based. That is, each sample in a sub-block is assigned its own weight. The weighting includes the weight for each prediction hypothesis. For example, for sub-block sb₀₀, p(x, y)=w₀(x,y)*p₀(x,y)+w₁(x,y)*p₁(x, y), where (x, y) is the sample position in the current block, p(x, y) is the blended predictor at (x, y), pᵢ(x, y) is the to-be-blended predictor for (x, y) from the hypothesis i and wᵢ(x, y) is the weight for pᵢ(x, y). The weight depends on the sample position within the current block, the block width or height of the current block, the cost of the representative intra prediction mode, and/or the distance between the sample position and the corresponding region which recommends the representative intra prediction for generating hypothesis i of prediction. For example, the prediction p₀ is generated by m₀ and pᵢ is generated by n₀. The weight w₀(x, y) can be

$$I + \frac{I * x}{W} - \frac{I * y}{H} ,$$

where I depends on a predefined summation of weights. The weight wᵢ is {the summation of weights}−w₀. If the summation of weighting is 64, I=half of 64=32. In some embodiments, the weighting may further depend on the costs of the representative intra prediction modes. The cost of m₀ is first normalized/scaled according to the corresponding top sub-region area/size and the cost of n₀ is first normalized/scaled according to the corresponding left sub-region area/size. For example, if the cost for m₀ is much larger than the cost from n₀, w₀ is reduced to

$$I + \frac{I * x}{W} - \frac{2 * I * y}{H} ;$$

if the cost for no is much larger than the cost from m₀, w₀ is increased to

$$I + \frac{2 I * x}{W} - \frac{I * y}{H} .$$

In some embodiments, when dividing the current block into subblocks, the prediction in overlapping regions between sub-blocks are further blended with the predictions generated by intra prediction modes used by neighbors. FIG. 15 also illustrates blending predictions for overlapping regions between sub-blocks of a current block. For example, for sub-block (or grid) sb₀₁, in additional to the original predicted samples in sb₀₁ (from the sub-region representative prediction modes m₀ and n₁), the overlapping region in the upper portion within sb₀₁ will further blend with the prediction generated according to no. The blending weight (e.g., 1) for the prediction from no will be smaller than the blending weight (e.g., 3) for the original predicted samples.

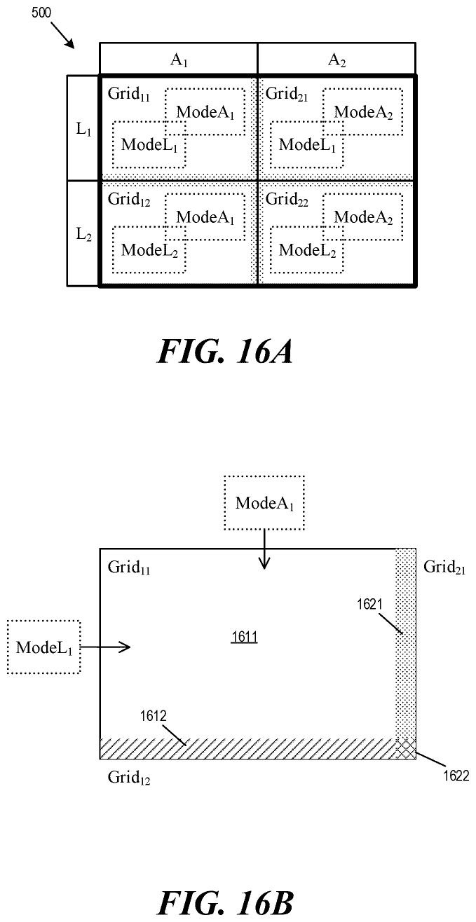

FIGS. 16A-B show overlapping blending predictions along boundaries between grids of the current block. FIG. 16A shows that, for the current block 500, two representative intra prediction modes (denoted as modeA₁ and modeA₂) may be taken from the above reference region (A₁ and A₂) and two representative intra prediction modes (denoted as modeL₁ and modeL₂) may be taken from the left reference region (L₁ and L₂).

FIG. 16B shows blending different intra predictions along grid boundaries. As illustrated, the grid₁₁ of the block 500 can be divided into four portions 1611, 1612, 1621, and 1622. Portion 1611 is away from boundaries/edges with other grids thus not blended the predictions generated using the intra prediction modes for other grids. Portion 1612 is at boundary with grid₁₂ thus blended with (1) intra prediction generated for the current grid (grid₁₁) by using the one or more intra prediction modes of grid₁₂ or (2) intra prediction of grid₁₂. An example of (1) is shown. The blended prediction of the portion 1612 is:

$$P ( x , y ) = ( 48 * ( blending predictions ( x , y ) from {ModeA}_{1} and {ModeL}_{1} ) + 16 * ( blending prediction ( x , y ) from {ModeA}_{1} and {ModeL}_{2} ) + 32 ) >> 6$$

Portion 1621 is at boundary with grid₂₁ thus blended with (1) intra prediction generated for the current grid (grid₁₁) by using the one or more intra prediction modes of grid₂₁ or (2) intra prediction of grid₂₁. An example of (1) is shown. The blended prediction of the portion 1621 is:

$$P ( x , y ) = ( 48 * ( blending predictions ( x , y ) from {ModeA}_{1} and {ModeL}_{1} ) + 16 * ( blending prediction ( x , y ) from {ModeA}_{1} and {ModeL}_{2} ) + 32 ) >> 6$$

Portion 1622 is at boundary with grid₂₁ and grid₁₂ thus blended with (1) intra predictions generated for the current grid by using the intra prediction modes of both grid₁₂ and grid₂₁ or (2) intra predictions of both grid₁₂ and grid₂₁. An example of (1) is shown. The blended prediction for the portion 1622 is:

$$P ( x , y ) = ( 32 * ( blending prediction ( x , y ) from {ModeA}_{1} and {ModeL}_{1} ) + 16 * ( blending prediction ( x , y ) from {ModeA}_{2} and {ModeL}_{1} ) + 16 * ( blending prediction ( x , y ) from {ModeA}_{1} and {ModeL}_{2} ) + 32 ) >> 6$$

Generally, let P_{c} is the blending prediction in the current grid and outside from the overlapping region in the current grid. Pᵣ is the blending prediction in the right overlapping region of the current grid. P_{b} is the blending prediction in the bottom overlapping region of the current grid. P_{rb} is the blending prediction in the right-bottom overlapping region of the current grid. For example:

$${P}_{c} ( x , y ) = blending prediction from {ModeA}_{1} and {ModeL}_{1}$$

$${P}_{r} ( x , y ) = ( 48 * ( blending prediction from {ModeA}_{1} and {ModeL}_{1} ) + 16 * ( blending prediction from {ModeA}_{2} and {ModeL}_{1} ) + 32 ) >> 6$$

$${P}_{b} ( x , y ) = ( 48 * ( blending prediction from {ModeA}_{1} and {ModeL}_{1} ) + 16 * ( blending prediction from {ModeA}_{1} and {ModeL}_{2} ) + 32 ) >> 6$$

$${P}_{rb} ( x , y ) = ( 32 * ( blending prediction from {ModeA}_{1} and {ModeL}_{1} ) + 16 * ( blending prediction from {ModeA}_{2} and {ModeL}_{1} ) + 16 * ( blending prediction from {ModeA}_{1} and {ModeL}_{2} ) + 32 ) >> 6$$

In some embodiments, the video coder prepares each prediction hypothesis for all samples in the current block and uses weighting to control the contribution of each hypothesis on different grids and/or overlapping area. In some embodiments, for each non-boundary grid (with size equal to gridW×gridH), the video coder prepares a hypotheses (with each size equal to (gridW+m1)×(gridH+m2)) for this grid and its outer adjacent overlapping area (such as preparing hypotheses from modeA₁ and modeL₁ for grid₁₁ and its outer adjacent overlapping area); similarly for each boundary grid (with size equal to gridW×gridH), to prepare the hypotheses for this grid and only its outer adjacent overlapping area within the current block. The video coder then uses weighting to control the contribution of each hypothesis on different grids and/or overlapping area. m1 and m2 refer to the width and height of the overlapping area.

In some embodiments, a general representative intra prediction mode is determined according to the entire top and left reference regions. A prediction hypothesis generated from the general representative intra prediction mode is further blended with the predicted samples in the current block. This may be referred to as the default blending.

In some embodiments, when dividing the current block into several subblocks, the size of each subblock is pre-defined, e.g., 4 samples×4 samples. In some embodiments, when dividing the current block into several sub-blocks, the total number of sub-blocks is predefined. For example, the total number of subblocks in the current block may be 16 (i.e., 4×4), so the size of each subblock is (the block width/4)×(the block height/4).

In some embodiments, (e.g., for the single mode and/or blending mode cases of TIMD and/or using region-based intra-prediction), when generating prediction for the current block, one or more reference lines of intra prediction is determined by an index indicating the reference line number (e.g. the multi-reference line (MRL) index). In some embodiments, at least one (or only one) prediction hypothesis is generated as a blending prediction from at least two reference lines. The blending prediction may be obtained through blending predicted signals (one from one reference line and another from another reference line) or through generating prediction by referencing the blended reference line. If two reference lines are used, the first line is the line indicated with the MRL index and the second line is the line outer-adjacent to the first line. In some embodiments (e.g., for the non-single mode cases of TIMD and/or using the proposed novel scheme), all prediction hypotheses is generated by using the only one reference line (indicated by the MRL index or associated with the MRL index).

In some embodiments, when supporting the proposed scheme with ISP or any intra mode which may divide the current block (such as current coding block) into multiple sub-blocks (such as transform blocks), the position (x, y) in the current block (instead of the position in the current transform block when the current block contains multiple transform blocks and/or the current block is not the first transform block in the current block) is used to derive the weighting for blending.

In some embodiments, the weighting includes the weight for each prediction hypothesis. For example, p(x, y)=w₀(x,y)*p₀ (x,y)+w₁(x,y)*p₁(x, y), where (x, y) is the sample position in the current block, p(x, y) is the blended predictor at (x, y), pᵢ(x, y) is the to-be-blended predictor for (x, y) from the hypothesis i and wᵢ(x, y) is the weight for pᵢ(x, y). The weighting depends on the sample position within the current block, the block width or height of the current block, the cost of the representative intra prediction mode, and/or the distance between the sample position and the corresponding region which recommends the representative intra prediction for generating prediction hypothesis i. For example, p₀ is generated by m₀ (the representative intra prediction mode from A) and p₁ is generated by n₀ (the representative intra prediction mode from L). The weight w0(x, y) can be

$$I + \frac{I * x}{W} - \frac{I * y}{H} ,$$

where I depends on the pre-defined summation of weights. The weight w₁ is (the summation of weights)−w₀. If the summation of weighting is 64, I=half of 64=32.

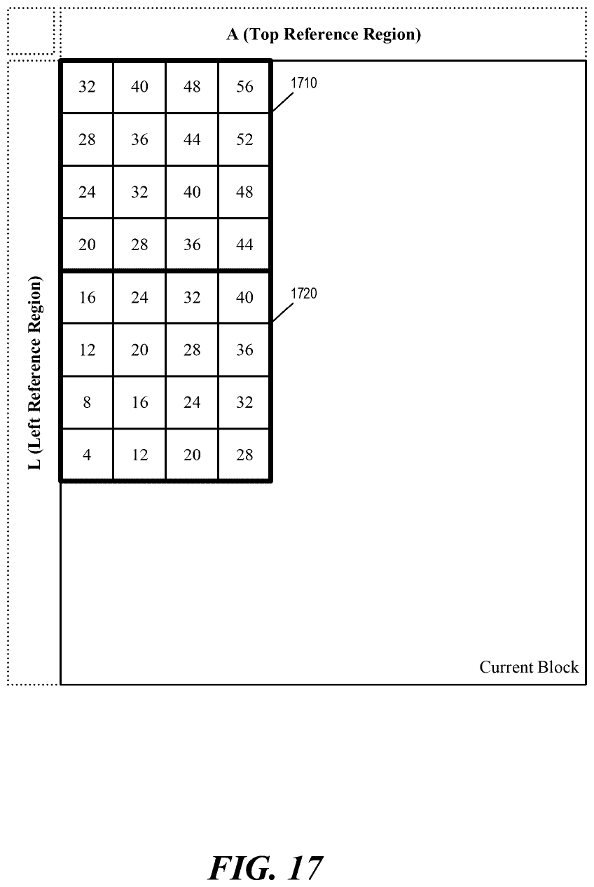

FIG. 17 shows sample-based weighting for different positions in different sub-blocks. The figure illustrates two adjacent sub-blocks 1710 and 1720 in a current block. Each of the sub-blocks has 4×4 samples at 16 different pixel positions. Each sample is assigned its own blending weight that is derived based on the sample's position in the current block (not the position in the sub-block). The number or value at each sample position (x, y) corresponds to the weight w₀(x, y) for that sample position in the current block. The sub-block can be a transform block split from the current block.

The weights are generated according to above method. For example, the sample at position x=0, y=4 is assigned weight value 16 according to the position in the current block, called coding block (CB) position, instead of according to x=0 and y=0 (the position in the transform block, referring to the bottom ISP transform block). The motivation of using CB position is that the reference regions are around the current block (not around the transform block); therefore, using CB position can make a larger weight for the representative intra prediction mode from a nearby reference region (either the top reference region or the left reference region). In another embodiment, if the reference regions are around the transform block, the position in the transform block is used to derive the weight.

### D. Mode Propagation

In some embodiments, a to-be-referenced intra prediction mode can be stored and/or propagated to be referenced by the subsequent coding blocks or the subsequent coding process of the current block. For example, a to-be-referenced intra prediction mode can be used in the MPM generation/chroma DM for the subsequent coding blocks. The to-be-referenced intra prediction mode can also be used in the subsequent transform process for the current block (e.g., primary transform such as DCT-II and/or Multiple Transform Selection (MTS) and/or non-separable primary transform, secondary transform such as Low Frequency Non-Separable Transform (LFNST)) of the current block. For an example of using for MTS, which includes multiple transform sets and/or multiple combinations of horizontal and vertical transforms in each transform set, the to-be-referenced intra prediction mode is used to select or determine the transform set for the current block, and/or the to-be-referenced intra prediction mode is used to select a combination from the transform set and/or to determine the order of combinations in the transform set. For an example of using for non-separable primary transform and/or secondary transform, the to-be-referenced intra prediction mode is used to select the transform set for the current block, and/or the to-be-referenced intra prediction mode maps to a transform set through a pre-defined table, and/or the transpose flag is determined using the to-be-referenced intra prediction mode. In some embodiments, the to-be-referenced intra prediction mode can be pre-defined as any one of available intra prediction modes such as DC, planar, angular modes, (67 intra prediction modes or 131 intra prediction modes.) In one embodiment, the to-be-referenced intra prediction mode is stored, and/or the to-be-referenced intra prediction mode may or may not be referenced by the following process of the current block and/or subsequent coding blocks.

In some embodiments, the to-be-referenced intra prediction mode can be pre-defined as any one of Gₖ, G′ₖ, and the best intra prediction mode from the original TIMD.

For the example of only one representative intra prediction mode (denoted as ModeA) from the above reference region (denoted as A) and only one representative intra prediction mode (denoted as ModeL) from the left reference region (denoted as L), the final representative intra prediction mode selected from either the above reference region or the left reference region is used. The selection may depend on the TIMD costs of intra prediction modes. The intra prediction mode with a smaller TIMD cost is selected.

For the example of two representative intra prediction modes (denoted as modeA₁ and modeA₂) from the above reference region and two representative intra prediction modes (denoted as modeL₁ and modeL₂) from left reference region, the final representative intra prediction mode selected from either one of the above sub-regions (such as rightmost sub-region A₂) or one of the left sub-regions (such as bottommost sub-region L₂) may be used as the to-be-referenced mode. The selection may depend on the TIMD costs of intra prediction modes. The intra prediction mode with a smaller TIMD cost is selected. (In some embodiments, when comparing the TIMD costs of intra prediction modes, the TIMD costs may be normalized first if those TIMD costs are from different size of regions.)

In some embodiments, as video coder uses multiple intra prediction modes to generate the prediction of the current block, the to-be-referenced intra prediction mode used in the transform process may not be a good mode to represent the prediction/residual distribution for finding or selecting the corresponding transform kernel. Therefore, the video coder may perform an additional predefined implicit derivation scheme (e.g., TIMD, DIMD, . . . ) on all or any subset of the predicted samples within the current block to derive the to-be-referenced intra prediction mode.

In some embodiments, one or more to-be-referenced intra prediction modes can be stored and/or be referenced by the subsequent coding blocks or the subsequent processing of the current block. The one or more to-be-referenced intra prediction modes may be determined following SGPM mode propagation. First, for each subblock (with size equal to 1×1, 2×2, 4×4, 8×8, 16×16, 32×32, or any pre-defined sub-block size) in the current block, the video coder will decide its own to-be-referenced intra prediction mode. When there is only one representative intra prediction mode (denoted as modeA) from the above reference region (denoted as A) and only one representative intra prediction mode (denoted as modeL) from the left reference region (denoted as L), when the subblock size is 2×2, the current block includes four subblocks. The first (top-left) subblock contains the samples with weight w₀ as 32, 40, 24, and 32 as shown in FIG. 14. The second (top-right) subblock contains the samples with blending weight w₀ as 48, 56, 40, and 48 as shown in FIG. 14. The third (bottom-left) subblock contains the samples with blending weight w₀ as 16, 24, 8, and 16 as shown in FIG. 14. The fourth (bottom-right) subblock contains the samples with w₀ as 32, 40, 24, and 32 as shown in FIG. 14.

In some embodiments, a pre-defined position in each sub-block is used to get the corresponding mode information of this position to determine the to-be-referenced intra prediction mode for this sub-block. The pre-defined position can be any pre-defined sample position in each subblock, such as the top-left sample in each subblock, the top-right sample in each subblock, the bottom-left sample in each subblock, the bottom-right sample in each subblock, or the center in each subblock. For example, the center position can be calculated by ((subblock width/2)+a, (subblock height/2)+b) in each subblock where (a, b)=(0, 0), (0, −1), (−1, 0), (0, 1), (1, 0), (1, 1), or (−1, −1). The corresponding mode information of this position indicates which intra prediction mode is preferred at this position. For example, if this position uses a higher weight for the prediction from modeA than modeL, modeA is preferred. For another example, if this position is nearer A than L, modeA is preferred. The preferred intra prediction mode for this position will be the to-be-referenced intra prediction mode for the subblock (containing this position). Similar method can be applied when the reference region is divided into multiple sub-regions. When two representative intra prediction modes (denoted as modeA₁ and modeA₂) from the top reference region and two representative intra prediction modes (denoted as modeL₁ and modeL₂) from the left reference region are used, for the subblocks in grid₁₁, the corresponding mode and/or cost information indicates which intra prediction mode (either modeA₁ or modeL₁) is preferred.

### E. Enabling Condition

In some embodiment, region-based intra-prediction method described in Section IV is enabled and/or disabled for the current block according to implicit rules (e.g., block location with the top and left regions being both available, block width, height, and/or area) or according to explicit rules (e.g., syntax on block, tile, slice, picture, SPS, or PPS level). For example, an additional flag may be signaled to indicate whether to apply region-based intra-prediction to the current block. For another example, region-based intra-prediction is treated as an optional mode of a target coding tool (e.g., TIMD). Therefore, when a flag indicates that TIMD is used for the current block, the additional flag for enabling region-based intra-prediction (e.g., FIG. 5 and/or FIG. 12 and/or any variation of region-based intra-prediction) may be signaled. In some embodiments, the flag for region-based intra-prediction is signaled when the top and left reference regions are both available.

In some embodiments, when region-based intra-prediction is applied to the current block, the division of the above reference region (e.g., whether to divide the above reference region and/or how many sub-regions are in the above reference region) are determined based on the block width. For example, when the block width is larger than a predefined threshold (such as 4, 8, or 16), the above reference region is divided into (e.g., 2) sub-regions for region-based intra-prediction.

In some embodiments, when region-based intra-prediction is applied to the current block, the division of the left reference region (e.g., whether to divide the left reference region and/or how many sub-regions are in the left reference region) are determined based on the block width. For example, when the block width is larger than a predefined threshold (such as 4, 8, or 16), the left reference region is divided into (e.g., 2) sub-regions for region-based intra-prediction.

In some embodiment, when the block width, height, or area is larger than a predefined threshold (e.g., 4, 8, 16, 32, 64, or 1024), and when the TIMD flag is true (i.e., TIMD is used to encode or decode the current block), region-based intra-prediction is performed instead of TIMD. In some embodiments, no additional flag is used to indicate whether to use region-based intra-prediction as long as the TIMD flag is true. In some embodiments, TIMD can support more block sizes, such that when the block width, height, or area is larger than a pre-defined threshold (e.g., 4, 8, 16, 32, 64, 1024, or a maximum (intra) block size specified in a video coding standard), TIMD can still be performed without constraint based on block size. In some embodiments, the TIMD size enabling condition is unified regardless slice types. That is, for both intra and inter slices, same size enabling condition may be used for TIMD.

In some embodiments, any proposed methods or any combinations of the proposed methods can be applied to luma, chroma components and/or other intra modes (not restricted to TIMD/DIMD) such as normal intra mode, WAIP, intra angular modes, ISP (intra-sub-partitions, which divides luma intra-predicted blocks vertically or horizontally into 2 or 4 sub-partitions depending on the block size), MIP (matrix weighted intra prediction, which takes samples from one line of reconstructed neighbouring boundary samples left of the block and/or samples from one line of reconstructed neighbouring boundary samples above the block for intra prediction as the input of the matrix for prediction generation), GPM (geometric partition mode, which partitions the current block and the reference regions according to one or more lines with specified angles and positions, and may use TIMD to derive one or more intra prediction modes for each of the partitions), SGPM (spatial GPM), any intra mode specified in the VVC or HEVC, CIIP (combined inter and intra prediction, which may use TIMD to derive one or more intra prediction modes), IBC (Intra block copy, which uses a block vector to indicate the displacement from the current block to a reference block that is already reconstructed inside the current picture), and/or any non-intra mode inter modes.

The proposed methods in this invention can be enabled and/or disabled according to implicit rules (e.g. block width, height, or area) or according to explicit rules (e.g., syntax on block, tile, slice, picture, SPS, or PPS level). For example, the proposed method is applied when the block area is smaller/larger than a threshold. The term “block” in this invention may refer to TU/TB, CU/CB, PU/PB, CTU/CTB, or any other pre-defined region. Any combination of the proposed methods in this invention can be applied.

Any of the foregoing proposed methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module.

### V. Example Video Encoder

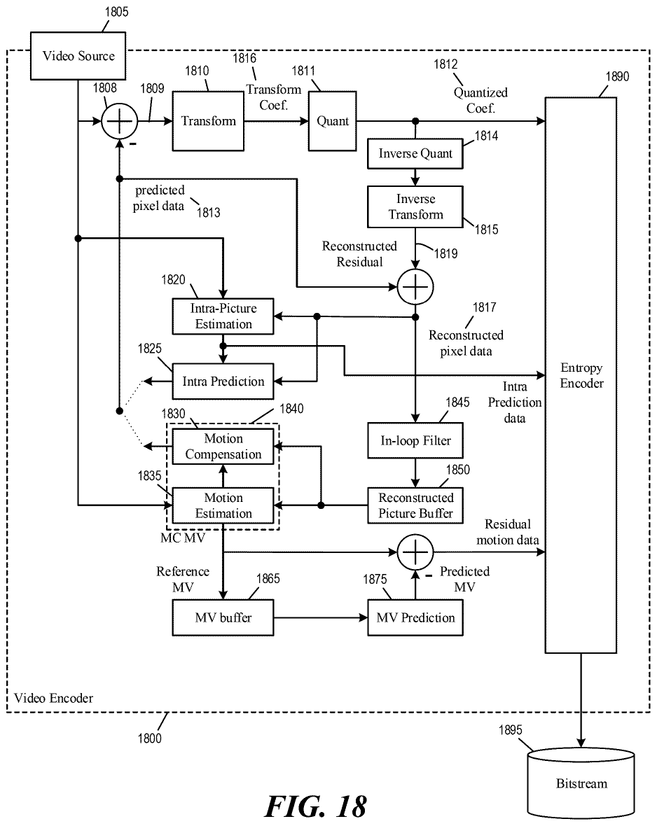

FIG. 18 illustrates an example video encoder 1800 that may perform region based intra-prediction. As illustrated, the video encoder 1800 receives input video signal from a video source 1805 and encodes the signal into bitstream 1895. The video encoder 1800 has several components or modules for encoding the signal from the video source 1805, at least including some components selected from a transform module 1810, a quantization module 1811, an inverse quantization module 1814, an inverse transform module 1815, an intra-picture estimation module 1820, an intra-prediction module 1825, a motion compensation module 1830, a motion estimation module 1835, an in-loop filter 1845, a reconstructed picture buffer 1850, a MV buffer 1865, and a MV prediction module 1875, and an entropy encoder 1890. The motion compensation module 1830 and the motion estimation module 1835 are part of an inter-prediction module 1840.

In some embodiments, the modules 1810-1890 are modules of software instructions being executed by one or more processing units (e.g., a processor) of a computing device or electronic apparatus. In some embodiments, the modules 1810-1890 are modules of hardware circuits implemented by one or more integrated circuits (ICs) of an electronic apparatus. Though the modules 1810-1890 are illustrated as being separate modules, some of the modules can be combined into a single module.

The video source 1805 provides a raw video signal that presents pixel data of each video frame without compression. A subtractor 1808 computes the difference between the raw video pixel data of the video source 1805 and the predicted pixel data 1813 from the motion compensation module 1830 or intra-prediction module 1825 as prediction residual 1809. The transform module 1810 converts the difference (or the residual pixel data or residual signal 1808) into transform coefficients (e.g., by performing Discrete Cosine Transform, or DCT). The quantization module 1811 quantizes the transform coefficients into quantized data (or quantized coefficients) 1812, which is encoded into the bitstream 1895 by the entropy encoder 1890.

The inverse quantization module 1814 de-quantizes the quantized data (or quantized coefficients) 1812 to obtain transform coefficients, and the inverse transform module 1815 performs inverse transform on the transform coefficients to produce reconstructed residual 1819. The reconstructed residual 1819 is added with the predicted pixel data 1813 to produce reconstructed pixel data 1817. In some embodiments, the reconstructed pixel data 1817 is temporarily stored in a line buffer (not illustrated) for intra-picture prediction and spatial MV prediction. The reconstructed pixels are filtered by the in-loop filter 1845 and stored in the reconstructed picture buffer 1850. In some embodiments, the reconstructed picture buffer 1850 is a storage external to the video encoder 1800. In some embodiments, the reconstructed picture buffer 1850 is a storage internal to the video encoder 1800.

The intra-picture estimation module 1820 performs intra-prediction based on the reconstructed pixel data 1817 to produce intra prediction data. The intra-prediction data is provided to the entropy encoder 1890 to be encoded into bitstream 1895. The intra-prediction data is also used by the intra-prediction module 1825 to produce the predicted pixel data 1813.

The motion estimation module 1835 performs inter-prediction by producing MVs to reference pixel data of previously decoded frames stored in the reconstructed picture buffer 1850. These MVs are provided to the motion compensation module 1830 to produce predicted pixel data.

Instead of encoding the complete actual MVs in the bitstream, the video encoder 1800 uses MV prediction to generate predicted MVs, and the difference between the MVs used for motion compensation and the predicted MVs is encoded as residual motion data and stored in the bitstream 1895.

The MV prediction module 1875 generates the predicted MVs based on reference MVs that were generated for encoding previously video frames, i.e., the motion compensation MVs that were used to perform motion compensation. The MV prediction module 1875 retrieves reference MVs from previous video frames from the MV buffer 1865. The video encoder 1800 stores the MVs generated for the current video frame in the MV buffer 1865 as reference MVs for generating predicted MVs.

The MV prediction module 1875 uses the reference MVs to create the predicted MVs. The predicted MVs can be computed by spatial MV prediction or temporal MV prediction. The difference between the predicted MVs and the motion compensation MVs (MC MVs) of the current frame (residual motion data) are encoded into the bitstream 1895 by the entropy encoder 1890.

The entropy encoder 1890 encodes various parameters and data into the bitstream 1895 by using entropy-coding techniques such as context-adaptive binary arithmetic coding (CABAC) or Huffman encoding. The entropy encoder 1890 encodes various header elements, flags, along with the quantized transform coefficients 1812, and the residual motion data as syntax elements into the bitstream 1895. The bitstream 1895 is in turn stored in a storage device or transmitted to a decoder over a communications medium such as a network.

The in-loop filter 1845 performs filtering or smoothing operations on the reconstructed pixel data 1817 to reduce the artifacts of coding, particularly at boundaries of pixel blocks. In some embodiments, the filtering or smoothing operations performed by the in-loop filter 1845 include deblock filter (DBF), sample adaptive offset (SAO), and/or adaptive loop filter (ALF).

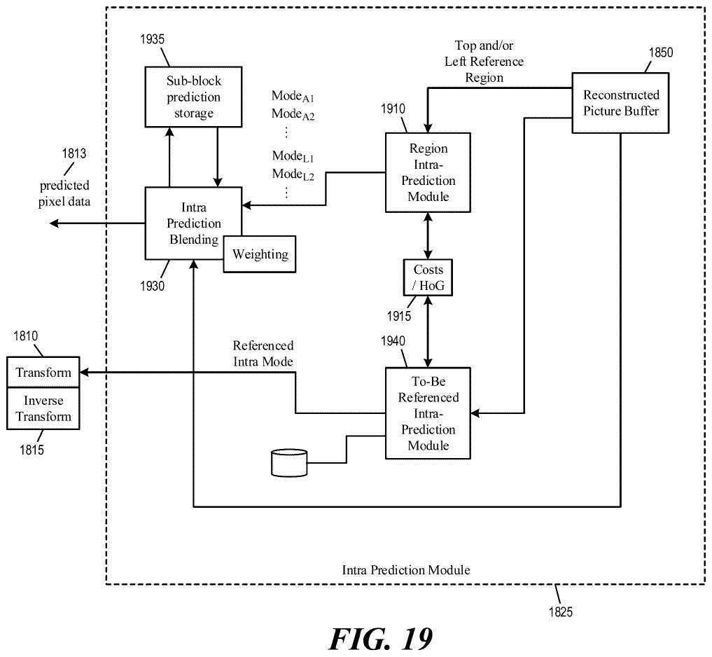

FIG. 19 illustrates portions of the video encoder 1800 that implement region-based intra prediction. Specifically, the figure illustrates the components of the intra-prediction module 1825 of the video encoder 1800. As illustrated, the intra-prediction module 1825 retrieves content from the reconstructed picture buffer 1850, which provides reconstructed pixel data from regions near the current block as templates.

As illustrated, the intra-prediction module 1825 includes a region-based intra-prediction module 1910. The region-based intra prediction module 1910 uses samples in the reference region (including the top reference region and/or the left reference region) of the current block to calculate costs or to accumulate HoG for different intra prediction modes for (1) different sub-regions of the reference region as shown in FIG. 5 and/or (2) above and left regions of the reference region as shown in FIG. 12. In some embodiments, the region-based intra prediction module 1910 may use neighboring pixels of the reference region or of the target region (e.g., one of sub-regions) to calculate the predictors on the target region for different intra prediction modes and calculate the costs on the target region for different intra prediction modes. In some embodiments, the region-based intra prediction module 1910 may use pixels of the target region (e.g. one of sub-regions) to calculate the HoGs for different intra prediction modes. Based on costs or HoGs (which may be stored in a cost/HOG storage 1915 or may not be stored), the region-based intra prediction 1910 identifies intra-prediction modes (e.g., ModeL₁, ModeL₂, ModeA₁, ModeA₂, etc.) for the sub-regions or intra-prediction modes (e.g., ModeL, ModeA, etc.) for the left and above reference regions.

A to-be-referenced intra-prediction module 1940 identifies one representative intra-prediction mode for the current block to be stored and propagated to subsequent coding blocks and/or referenced by subsequent processing, such as the transform and inverse transform operation by the transform and inverse transform modules 1810 and 1815. The to-be-referenced intra-prediction module 1940 may use the samples stored in the reconstructed picture buffer 1850 or the samples of the final or temporary predictor of the current block to determine the to-be-referenced intra-prediction mode, or select one of the current block's MPMs, or one of representative the intra-prediction modes of the sub-regions or any pre-defined region, as the to-be-referenced intra-prediction mode of the current block.

An intra prediction blending module 1930 receives the identified intra-prediction modes using the sub-regions and/or any pre-defined regions. The intra prediction blending module 1930 may blend predictions produced by different intra-prediction modes to become the predictor for the current block. The weighting for blending the different intra-predictions may be subject to sample positions. The result of the intra prediction blending can be used as the predicted pixel data 1813.

The current block may be a sub-block or a grid of a larger block that is divided into sub-blocks or grids. The intra prediction blending module 1930 may store prediction samples along the boundaries of the current block in a sub-block prediction storage 1935 to be used later for blending with other sub-blocks or grids. In another way, the intra prediction blending module 1930 may generate the prediction with size larger than the current block (the current sub-block or the current grid) and may store prediction samples along the boundaries and outside from the current block in a sub-block prediction storage 1935 to be used later for blending with other sub-blocks or grids.

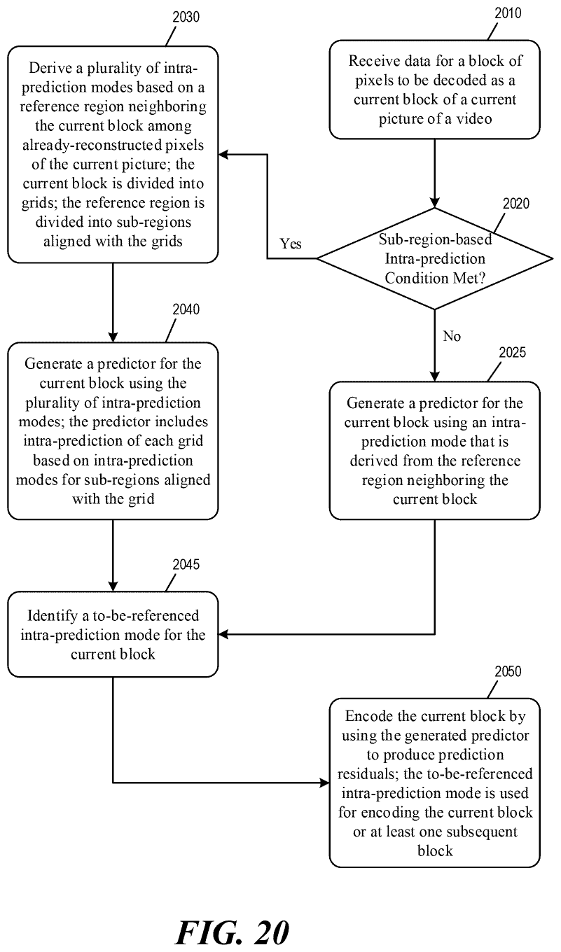

FIG. 20 conceptually illustrates a process 2000 for using region-based intra-prediction to encode the current block. In some embodiments, one or more processing units (e.g., a processor) of a computing device implementing the encoder 1800 performs the process 2000 by executing instructions stored in a computer readable medium. In some embodiments, an electronic apparatus implementing the encoder 1800 performs the process 2000.

The encoder receives (at block 2010) data for a block of pixels to be encoded or decoded as a current block of a current picture.

The encoder determines (at block 2020) whether to use sub-region intra-prediction to encode the current block. In some embodiments, the encoder uses sub-region intra-prediction if a size of the current block (e.g., width and/or height) is greater than a threshold. If sub-region intra-prediction is to be used, the process proceeds to block 2030. If the region-based intra-prediction is not to be used (e.g., the current block is smaller than or not greater than the threshold size), the encoder generates (at block 2025) a predictor for the current block using an intra-prediction mode that is derived from the reference region neighboring the current block.

The encoder derives (at block 2030) a plurality of intra-prediction modes based on a reference region neighboring the current block among already-reconstructed pixels of the current picture. The reference region includes an above reference region and a left reference region that are/is divided into multiple sub-regions. The current block is divided into grids and the sub-regions of the top and left reference regions are aligned with the grids. In some embodiments, (at least one of) the plurality of intra-prediction modes includes (at least one of) respective representative intra-prediction modes corresponding to the plurality of sub-regions, and/or for each sub-region, samples neighboring the sub-region or the whole reference region are used to generate predictor for each candidate intra-prediction mode to identify the representative intra-prediction mode of the sub-region based on the costs and/or HoGs.

The encoder generates (at block 2040) a predictor for the current block using the plurality of intra-prediction modes. The predictor includes intra-prediction of each grid based on intra-prediction modes for sub-regions aligned with the grid. In some embodiments, the predictor of a grid is generated by blending a first intra prediction generated by a first intra-prediction mode derived from the above region or a sub-region of the above reference region aligned with the grid and a second intra prediction generated by a second intra-prediction mode derived from the left reference region or a sub-region of the left reference region aligned with the grid. In some embodiments, the first and second intra predictions at a sample in the grid are blended according to a weighting that is assigned based on the sample's respective distances from the above and left reference regions.

In some embodiments, the encoder generates the predictor of a first grid by blending a first intra prediction generated by a first intra-prediction mode derived from a first sub-region aligned with the first grid and a second intra prediction generated by a second intra-prediction mode derived from a second sub-region aligned with the second grid that is adjacent to the first grid.

In some embodiments, when a first cost based on a plurality of costs of respective representative intra-prediction modes corresponding to the plurality of sub-regions in the above reference region or the left reference region is less than a second cost of using a representative intra-prediction mode of the above reference region or the left reference region by considering a threshold, the predictor of the current block is generated by using at least one of the respective representative intra-prediction modes corresponding to the plurality of sub-regions in the above reference region or the left reference region. Otherwise, the predictor of the current block is generated by using the representative intra-prediction mode from the above reference region or the left reference region.

The encoder identifies (at block 2045) a to-be-referenced intra-prediction mode for the current block. The encoder encodes (at block 2050) the current block by using the generated predictor to produce prediction residuals. In some embodiments, the to-be-referenced intra prediction mode is stored for the current block or propagated to the at least one subsequent block. The to-be-referenced intra prediction mode may be selected from a set of intra prediction modes based on costs, with the selected intra prediction mode from the set of intra prediction modes derived using predicted samples of the current block or reconstructed samples neighboring the current block. In some embodiments, the encoder encodes the current block by transforming a residual of the predictor or transformed coefficients of the residual using a transform mode that is selected based on the to-be-referenced intra prediction mode. The encoder may also provide the to-be-referenced intra prediction mode for use as a most probable mode (MPM) for encoding a subsequent block.

### VI. Example Video Decoder

In some embodiments, an encoder may signal (or generate) one or more syntax element in a bitstream, such that a decoder may parse said one or more syntax element from the bitstream.

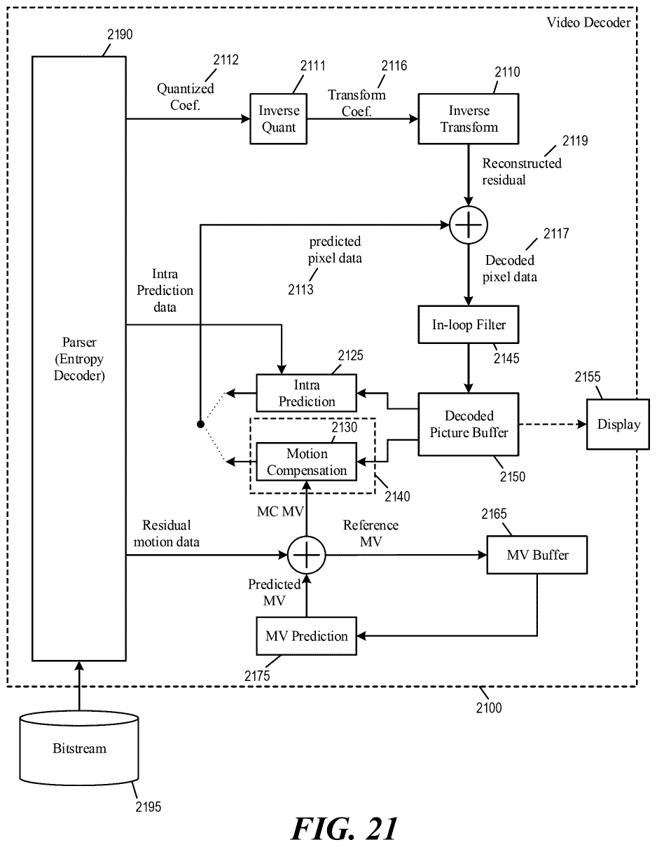

FIG. 21 illustrates an example video decoder 2100 that may perform region based intra-prediction. As illustrated, the video decoder 2100 is an image-decoding or video-decoding circuit that receives a bitstream 2195 and decodes the content of the bitstream into pixel data of video frames for display. The video decoder 2100 has several components or modules for decoding the bitstream 2195, including some components selected from an inverse quantization module 2111, an inverse transform module 2110, an intra-prediction module 2125, a motion compensation module 2130, an in-loop filter 2145, a decoded picture buffer 2150, a MV buffer 2165, a MV prediction module 2175, and a parser 2190. The motion compensation module 2130 is part of an inter-prediction module 2140.

In some embodiments, the modules 2110-2190 are modules of software instructions being executed by one or more processing units (e.g., a processor) of a computing device. In some embodiments, the modules 2110-2190 are modules of hardware circuits implemented by one or more ICs of an electronic apparatus. Though the modules 2110-2190 are illustrated as being separate modules, some of the modules can be combined into a single module.

The parser 2190 (or entropy decoder) receives the bitstream 2195 and performs initial parsing according to the syntax defined by a video-coding or image-coding standard. The parsed syntax element includes various header elements, flags, as well as quantized data (or quantized coefficients) 2112. The parser 2190 parses out the various syntax elements by using entropy-coding techniques such as context-adaptive binary arithmetic coding (CABAC) or Huffman encoding.

The inverse quantization module 2111 de-quantizes the quantized data (or quantized coefficients) 2112 to obtain transform coefficients, and the inverse transform module 2110 performs inverse transform on the transform coefficients 2116 to produce reconstructed residual signal 2119. The reconstructed residual signal 2119 is added with predicted pixel data 2113 from the intra-prediction module 2125 or the motion compensation module 2130 to produce decoded pixel data 2117. The decoded pixels data are filtered by the in-loop filter 2145 and stored in the decoded picture buffer 2150. In some embodiments, the decoded picture buffer 2150 is a storage external to the video decoder 2100. In some embodiments, the decoded picture buffer 2150 is a storage internal to the video decoder 2100.

The intra-prediction module 2125 receives intra-prediction data from bitstream 2195 and according to which, produces the predicted pixel data 2113 from the decoded pixel data 2117 stored in the decoded picture buffer 2150. In some embodiments, the decoded pixel data 2117 is also stored in a line buffer (not illustrated) for intra-picture prediction and spatial MV prediction.

In some embodiments, the content of the decoded picture buffer 2150 is used for display. A display device 2155 either retrieves the content of the decoded picture buffer 2150 for display directly, or retrieves the content of the decoded picture buffer to a display buffer. In some embodiments, the display device receives pixel values from the decoded picture buffer 2150 through a pixel transport.

The motion compensation module 2130 produces predicted pixel data 2113 from the decoded pixel data 2117 stored in the decoded picture buffer 2150 according to motion compensation MVs (MC MVs). These motion compensation MVs are decoded by adding the residual motion data received from the bitstream 2195 with predicted MVs received from the MV prediction module 2175.

The MV prediction module 2175 generates the predicted MVs based on reference MVs that were generated for decoding previous video frames, e.g., the motion compensation MVs that were used to perform motion compensation. The MV prediction module 2175 retrieves the reference MVs of previous video frames from the MV buffer 2165. The video decoder 2100 stores the motion compensation MVs generated for decoding the current video frame in the MV buffer 2165 as reference MVs for producing predicted MVs.

The in-loop filter 2145 performs filtering or smoothing operations on the decoded pixel data 2117 to reduce the artifacts of coding, particularly at boundaries of pixel blocks. In some embodiments, the filtering or smoothing operations performed by the in-loop filter 2145 include deblock filter (DBF), sample adaptive offset (SAO), and/or adaptive loop filter (ALF).

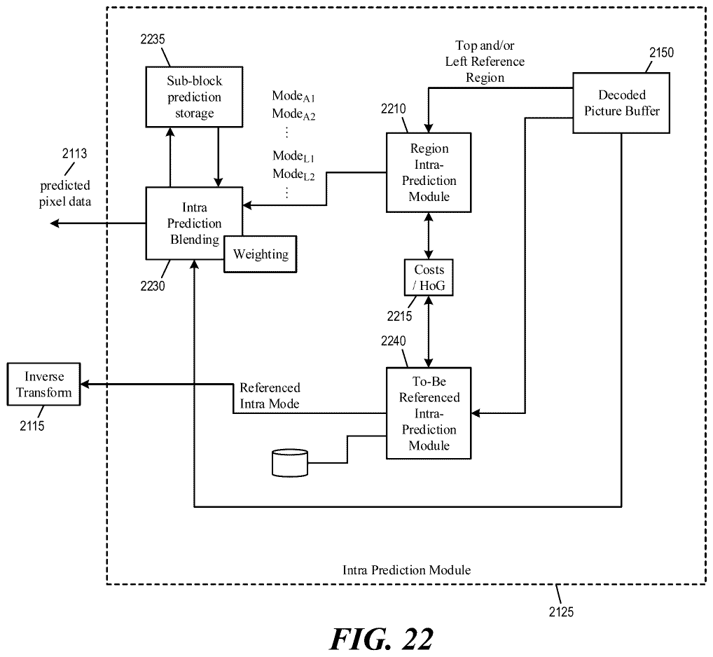

FIG. 22 illustrates portions of the video decoder 2100 that implement region-based intra prediction. Specifically, the figure illustrates the components of the intra-prediction module 2125 of the video decoder 2100. As illustrated, the intra-prediction module 2125 retrieves content from the decoded picture buffer 2150, which provides reconstructed pixel data from regions near the current block as templates.

As illustrated, the intra-prediction module 2125 includes a region-based intra-prediction module 2210. The region-based intra prediction module 2210 uses samples in the reference region (including the top reference region and/or the left reference region) of the current block to calculate costs or to accumulate HoG for different intra prediction modes for (1) different sub-regions of the reference region as shown in FIG. 5 and/or (2) above and left regions of the reference region as shown in FIG. 12. In some embodiments, the region-based intra prediction module 2210 may use neighboring pixels of the reference region or of the target region (e.g. one of sub-regions) to calculate the predictors on the target region for different intra prediction modes and calculate the costs on the target region for different intra prediction modes. In some embodiments, the region-based intra prediction module 2210 may use pixels of the target region (e.g. one of sub-regions) to calculate the HoGs for different intra prediction modes. Based on costs or HoGs (which may be stored in a cost/HoG storage 2215 or may not be stored), the region-based intra prediction 2210 identifies intra-prediction modes (e.g., ModeL₁, ModeL₂, ModeA₁, ModeA₂, etc.) for the sub-regions or intra-prediction modes (e.g., ModeL, ModeA, etc.) for the left and above reference regions.

A to-be-referenced intra-prediction module 2240 identifies one representative intra-prediction mode for the current block to be stored and propagated to subsequent coding blocks and/or referenced by subsequent processing, such as the inverse transform operations by the inverse transform module 2110. The to-be-referenced intra-prediction module 2240 may use the samples stored in the reconstructed picture buffer 2150 or the samples of the final or temporary predictor of the current block to determine the to-be-referenced intra-prediction mode, or select one of the current block's MPMs, or one of the representative intra-prediction modes of the sub-regions or any pre-defined region, as the to-be-referenced intra-prediction mode of the current block.

An intra prediction blending module 2230 receives the identified intra-prediction modes using the sub-regions and/or any pre-defined regions. The intra prediction blending module 2230 may blend predictions produced by different intra-prediction modes to become the predictor for the current block. The weighting for blending the different intra-predictions may be subject to sample positions. The result of the intra prediction blending can be used as the predicted pixel data 2113.

The current block may be a sub-block or a grid of a larger block that is divided into sub-blocks or grids. The intra prediction blending module 2230 may store prediction samples along the boundaries of the current block in a sub-block prediction storage 2235 to be used later for blending with other sub-blocks or grids. In another way, the intra prediction blending module 2230 may generate the prediction with size larger than the current block (the current sub-block or the current grid) and may store prediction samples along the boundaries and outside from the current block in a sub-block prediction storage 2235 to be used later for blending with other sub-blocks or grids.

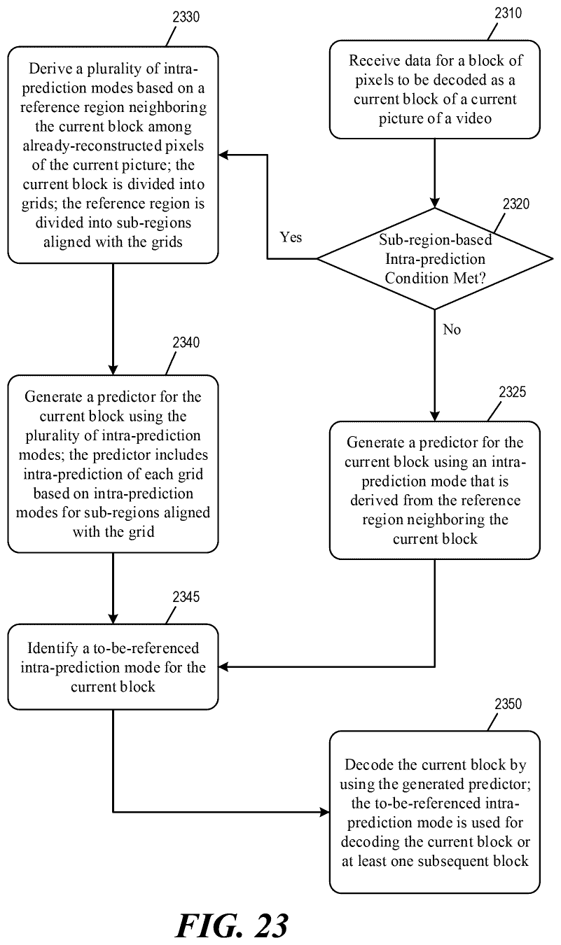

FIG. 23 conceptually illustrates a process 2300 for using region-based intra-prediction to decode the current block. In some embodiments, one or more processing units (e.g., a processor) of a computing device implementing the decoder 2100 performs the process 2300 by executing instructions stored in a computer readable medium. In some embodiments, an electronic apparatus implementing the decoder 2100 performs the process 2300.

The decoder receives (at block 2310) data for a block of pixels to be decoded or decoded as a current block of a current picture.

The decoder determines (at block 2320) whether to use sub-region intra-prediction to decode the current block. In some embodiments, the decoder uses sub-region intra-prediction if a size of the current block (e.g., width and/or height) is greater than a threshold. If sub-region intra-prediction is to be used, the process proceeds to block 2330. If the region-based intra-prediction is not to be used (e.g., the current block is smaller than or not greater than the threshold size), the decoder generates (at block 2325) a predictor for the current block using an intra-prediction mode that is derived from the reference region neighboring the current block.

The decoder derives (at block 2330) a plurality of intra-prediction modes based on a reference region neighboring the current block among already-reconstructed pixels of the current picture. The reference region includes an above reference region and/or a left reference region that are/is divided into multiple sub-regions. The current block is divided into grids and the sub-regions of the top and left reference regions are aligned with the grids. In some embodiments, (at least one of) the plurality of intra-prediction modes includes (at least one of) respective representative intra-prediction modes corresponding to the plurality of sub-regions, and/or for each sub-region, samples neighboring the sub-region or the whole reference region are used to generate predictor for each candidate intra-prediction mode to identify the representative intra-prediction mode of the sub-region based on the costs and/or HoGs.

The decoder generates (at block 2340) a predictor for the current block using the plurality of intra-prediction modes. The predictor includes intra-prediction of each grid based on intra-prediction modes for sub-regions aligned with the grid. In some embodiments, the predictor of a grid is generated by blending a first intra prediction generated by a first intra-prediction mode derived from the above region or a sub-region of the above reference region aligned with the grid and a second intra prediction generated by a second intra-prediction mode derived from the left reference region or a sub-region of the left reference region aligned with the grid. In some embodiments, the first and second intra predictions at a sample in the grid are blended according to a weighting that is assigned based on the sample's respective distances from the above and left reference regions.

In some embodiments, the decoder generates the predictor of a first grid by blending a first intra prediction generated by a first intra-prediction mode derived from a first sub-region aligned with the first grid and a second intra prediction generated by a second intra-prediction mode derived from a second sub-region aligned with the second grid that is adjacent to the first grid.

In some embodiments, when a first cost based on a plurality of costs of respective representative intra-prediction modes corresponding to the plurality of sub-regions in the above reference region or the left reference region is less than a second cost of using a representative intra-prediction mode of the above reference region or the left reference region by considering a threshold, the predictor of the current block is generated by using at least one of the respective representative intra-prediction modes corresponding to the plurality of sub-regions in the above reference region or the left reference region. Otherwise, the predictor of the current block is generated by using the representative intra-prediction mode from the above reference region or the left reference region.

The decoder identifies (at block 2345) a to-be-referenced intra-prediction mode for the current block. The decoder reconstructs (at block 2350) the current block by using the generated predictor. In some embodiments, the to-be-referenced intra prediction mode is stored for the current block or propagated to the at least one subsequent block. The to-be-referenced intra prediction mode may be selected from a set of intra prediction modes based on costs, with the selected intra prediction mode from the set of intra prediction modes derived using predicted samples of the current block or reconstructed samples neighboring the current block. In some embodiments, the decoder decodes the current block by inverse transforming transformed coefficients of the residual using a transform mode that is selected based on the to-be-referenced intra prediction mode. The decoder may also provide the to-be-referenced intra prediction mode for use as a most probable mode (MPM) for decoding a subsequent block.

### VII. Example Electronic System

Many of the above-described features and applications are implemented as software processes that are specified as a set of instructions recorded on a computer readable storage medium (also referred to as computer readable medium). When these instructions are executed by one or more computational or processing unit(s) (e.g., one or more processors, cores of processors, or other processing units), they cause the processing unit(s) to perform the actions indicated in the instructions. Examples of computer readable media include, but are not limited to, CD-ROMs, flash drives, random-access memory (RAM) chips, hard drives, erasable programmable read only memories (EPROMs), electrically erasable programmable read-only memories (EEPROMs), etc. The computer readable media does not include carrier waves and electronic signals passing wirelessly or over wired connections.

In this specification, the term “software” is meant to include firmware residing in read-only memory or applications stored in magnetic storage which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the present disclosure. In some embodiments, the software programs, when installed to operate on one or more electronic systems, define one or more specific machine implementations that execute and perform the operations of the software programs.

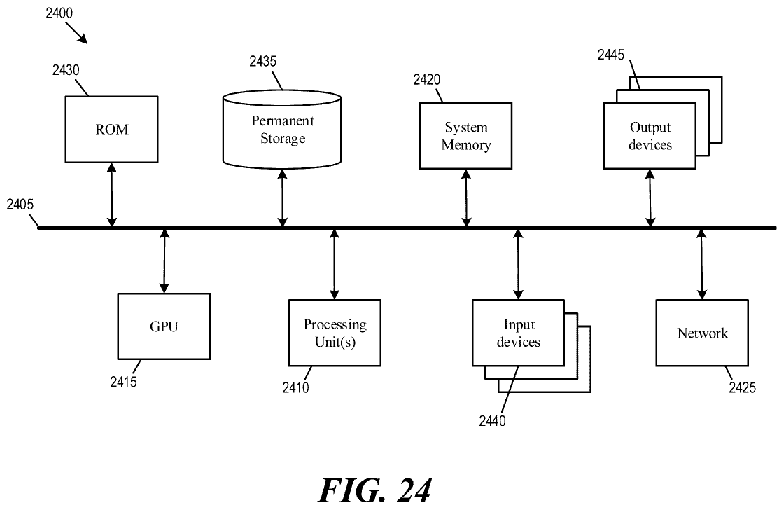

FIG. 24 conceptually illustrates an electronic system 2400 with which some embodiments of the present disclosure are implemented. The electronic system 2400 may be a computer (e.g., a desktop computer, personal computer, tablet computer, etc.), phone, PDA, or any other sort of electronic device. Such an electronic system includes various types of computer readable media and interfaces for various other types of computer readable media. Electronic system 2400 includes a bus 2405, processing unit(s) 2410, a graphics-processing unit (GPU) 2415, a system memory 2420, a network 2425, a read-only memory 2430, a permanent storage device 2435, input devices 2440, and output devices 2445.

The bus 2405 collectively represents all system, peripheral, and chipset buses that communicatively connect the numerous internal devices of the electronic system 2400. For instance, the bus 2405 communicatively connects the processing unit(s) 2410 with the GPU 2415, the read-only memory 2430, the system memory 2420, and the permanent storage device 2435.

From these various memory units, the processing unit(s) 2410 retrieves instructions to execute and data to process in order to execute the processes of the present disclosure. The processing unit(s) may be a single processor or a multi-core processor in different embodiments. Some instructions are passed to and executed by the GPU 2415. The GPU 2415 can offload various computations or complement the image processing provided by the processing unit(s) 2410.

The read-only-memory (ROM) 2430 stores static data and instructions that are used by the processing unit(s) 2410 and other modules of the electronic system. The permanent storage device 2435, on the other hand, is a read-and-write memory device. This device is a non-volatile memory unit that stores instructions and data even when the electronic system 2400 is off. Some embodiments of the present disclosure use a mass-storage device (such as a magnetic or optical disk and its corresponding disk drive) as the permanent storage device 2435.

Other embodiments use a removable storage device (such as a floppy disk, flash memory device, etc., and its corresponding disk drive) as the permanent storage device. Like the permanent storage device 2435, the system memory 2420 is a read-and-write memory device. However, unlike storage device 2435, the system memory 2420 is a volatile read-and-write memory, such a random access memory. The system memory 2420 stores some of the instructions and data that the processor uses at runtime. In some embodiments, processes in accordance with the present disclosure are stored in the system memory 2420, the permanent storage device 2435, and/or the read-only memory 2430. For example, the various memory units include instructions for processing multimedia clips in accordance with some embodiments. From these various memory units, the processing unit(s) 2410 retrieves instructions to execute and data to process in order to execute the processes of some embodiments.

The bus 2405 also connects to the input and output devices 2440 and 2445. The input devices 2440 enable the user to communicate information and select commands to the electronic system. The input devices 2440 include alphanumeric keyboards and pointing devices (also called “cursor control devices”), cameras (e.g., webcams), microphones or similar devices for receiving voice commands, etc. The output devices 2445 display images generated by the electronic system or otherwise output data. The output devices 2445 include printers and display devices, such as cathode ray tubes (CRT) or liquid crystal displays (LCD), as well as speakers or similar audio output devices. Some embodiments include devices such as a touchscreen that function as both input and output devices.

Finally, as shown in FIG. 24, bus 2405 also couples electronic system 2400 to a network 2425 through a network adapter (not shown). In this manner, the computer can be a part of a network of computers (such as a local area network (“LAN”), a wide area network (“WAN”), or an Intranet, or a network of networks, such as the Internet. Any or all components of electronic system 2400 may be used in conjunction with the present disclosure.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, many of the above-described features and applications are performed by one or more integrated circuits, such as application specific integrated circuits (ASICs) or field programmable gate arrays (FPGAs). In some embodiments, such integrated circuits execute instructions that are stored on the circuit itself. In addition, some embodiments execute software stored in programmable logic devices (PLDs), ROM, or RAM devices.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

While the present disclosure has been described with reference to numerous specific details, one of ordinary skill in the art will recognize that the present disclosure can be embodied in other specific forms without departing from the spirit of the present disclosure. In addition, a number of the figures (including FIG. 20 and FIG. 23) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the present disclosure is not to be limited by the foregoing illustrative details, but rather is to be defined by the appended claims.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A video coding method comprising:
receiving data for a block of pixels to be encoded or decoded as a current block of a current picture of a video;
deriving a plurality of intra-prediction modes based on a reference region neighboring the current block among already-reconstructed pixels of the current picture;
generating a predictor for the current block using at least one of the plurality of intra-prediction modes;
identifying a to-be-referenced intra-prediction mode for the current block; and
encoding or decoding the current block by using the generated predictor to reconstruct the current block, wherein the to-be-referenced intra-prediction mode is used for encoding or decoding the current block or at least one subsequent block.

2. The video coding method of claim 1, wherein:
the reference region comprises at least one of an above reference region that is divided into a plurality of sub-regions and a left reference region that is divided into a plurality of sub-regions,
the plurality of intra-prediction modes comprises intra-prediction modes that are derived based on the plurality of sub-regions of the reference region,
the current block is divided into a plurality of grids that are aligned with the sub-regions in at least one of the above and left reference regions;
wherein generating the predictor of the current block comprises generating an intra-prediction for each grid based on two or more intra-prediction modes.

3. The video coding method of claim 2, wherein the predictor for a grid is generated by blending
a first intra prediction generated by a first intra-prediction mode derived from the above reference region or a sub-region of the above reference region aligned with the grid and
a second intra prediction generated by a second intra-prediction mode derived from the left reference region or a sub-region of the left reference region aligned with the grid,
wherein the first and second intra predictions at a sample in the grid are blended according to a weighting that is assigned based on the sample's respective distances from the above and left reference regions.

4. The video coding method of claim 2, wherein generating the predictor of a first grid comprises blending
a first intra prediction generated by a first intra-prediction mode derived from a first sub-region aligned with the first grid and
a second intra prediction generated by a second intra-prediction mode derived from a second sub-region aligned with the second grid that is adjacent to the first grid.

5. The video coding method of claim 2, wherein:
when a first cost based on a plurality of costs of respective representative intra-prediction modes corresponding to the plurality of sub-regions in the above reference region or the left reference region is less than a second cost of using a representative intra-prediction mode of the above reference region or the left reference region by considering a threshold, the predictor of the current block is generated by using at least one of the respective representative intra-prediction modes corresponding to the plurality of sub-regions in the above reference region or the left reference region; or
when the first cost is not less than the second cost by considering the threshold, the predictor of the current block is generated by using the representative intra-prediction mode from the above reference region or the left reference region.

6. The video coding method of claim 2, wherein at least one of the plurality of intra-prediction modes comprises at least one of respective representative intra-prediction modes corresponding to the plurality of sub-regions.

7. The video coding method of claim 6, wherein for each sub-region, samples neighboring the sub-region are used to identify the representative intra-prediction mode of the sub-region.

8. The video coding method of claim 1, further comprising:
when a size of the current block is greater than a threshold:
dividing the current block into grids and the reference region into a plurality of sub-regions that are aligned with the grids of the current block,
deriving one or more intra-prediction modes for each sub-region of the plurality of sub-regions;
generating an intra-prediction for each grid based on intra-prediction modes for sub-regions that are aligned with the grid; and
using the intra-prediction for each grid to generate the predictor of the current block.

9. The video coding method of claim 1, wherein the to-be-referenced intra prediction mode is stored for the current block or propagated to the at least one subsequent block.

10. The video coding method of claim 9, wherein the to-be-referenced intra prediction mode is selected from a set of intra prediction modes based on costs, wherein the selected intra prediction mode from the set of intra prediction modes is derived using predicted samples of the current block or reconstructed samples neighboring the current block.

11. The video coding method of claim 9, wherein encoding or decoding the current block comprises using a transform mode that is selected based on the to-be-referenced intra prediction mode to perform transform or inverse transform.

12. The video coding method of claim 9, further comprising providing the to-be-referenced intra prediction mode as a most probable mode (MPM) for encoding or decoding a subsequent block.

13. An electronic apparatus comprising:
a video coder circuit configured to perform operations comprising:
receiving data for a block of pixels to be encoded or decoded as a current block of a current picture of a video;
deriving a plurality of intra-prediction modes based on a reference region neighboring the current block among already-reconstructed pixels of the current picture;
generating a predictor for the current block using at least one of the plurality of intra-prediction modes;
identifying a to-be-referenced intra-prediction mode for the current block; and
encoding or decoding the current block by using the generated predictor to reconstruct the current block, wherein the to-be-referenced intra-prediction mode is used for encoding or decoding the current block or at least one subsequent block.

14. A video decoding method comprising:
receiving data for a block of pixels to be decoded as a current block of a current picture of a video;
deriving a plurality of intra-prediction modes based on a reference region neighboring the current block among already-reconstructed pixels of the current picture;
generating a predictor for the current block using at least one of the plurality of intra-prediction modes;
identifying a to-be-referenced intra-prediction mode for the current block; and
decoding the current block by using the generated predictor,
wherein the to-be-referenced intra-prediction mode is used for decoding the current block or at least one subsequent block.

15. A video encoding method comprising:
receiving data for a block of pixels to be encoded as a current block of a current picture of a video;
deriving a plurality of intra-prediction modes based on a reference region neighboring the current block among already-reconstructed pixels of the current picture;
generating a predictor for the current block using at least one of the plurality of intra-prediction modes;
identifying a to-be-referenced intra-prediction mode for the current block; and
encoding the current block by using the generated predictor to generate residuals,
wherein the to-be-referenced intra-prediction mode is used for encoding the current block or at least one subsequent block.
